(19) United States
(12) Patent Application Publication
(10) Pub. No.: US 2026/0197048 A1
(43) Pub. Date: Jul. 9, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/863,888

(22) PCT Filed: May 15, 2023
(86) PCT No.: PCT/JP2023/018038

§ 371 Date: Nov. 7, 2024

(30) Foreign Application Priority Data
May 19, 2022 (JP) 2022-082340

(51) Int. Cl. H04B 7/06

(52) U.S. Cl. CPC H04B 7/0626

(57) ABSTRACT

To appropriately perform a group-based beam reporting related to UL transmission. A terminal according to one aspect of the present disclosure includes a receiving section that receives resource information related to a channel state information resource available for UL group-based beam reporting, and a control section that performs channel state information reporting including at least one of UL group-based beam reporting and DL group-based beam reporting, based on the resource information.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 and Rel-16 NR, a UE configured with group-based beam reporting enabled supports reporting of two different beam indices for each report configuration. In Rel. 17, enhancements related to beam management for a user terminal (User Equipment (UE)) with multiple panels (multi-panel), multiple transmission/reception points (multi-Transmission/Reception Points (TRPs)), and the like are supported.

In Rel. 18 and later versions, it is also assumed to introduce/support group-based beam reporting related to UL transmission.

However, how to perform the group-based beam reporting related to UL transmission has not been studied yet. If this is not clarified, appropriate communication between a TRP(s) and a UE cannot be performed, and communication throughput may be reduced.

In view of this, an object of the present disclosure is to provide a terminal, a radio communication method, and a base station that can appropriately perform group-based beam reporting related to UL transmission.

### Solution to Problem

A terminal according to one aspect of the present disclosure includes a receiving section that receives resource information related to a channel state information resource available for UL group-based beam reporting, and a control section that performs channel state information reporting including at least one of UL group-based beam reporting and DL group-based beam reporting, based on the resource information.

Advantageous Effects of Invention According to one aspect of the present disclosure, it is possible to appropriately perform group-based beam reporting related to UL transmission.

### BRIEF DESCRIPTION OF DRAWINGS

FIG. 1 FIG. 1A and FIG. 1B are diagrams to show examples of RRC information elements related to CSI report configuration and CSI resource configuration.

FIG. 2 FIG. 2A and FIG. 2B are diagrams to show examples of RRC information elements related to an NZP CSI-RS resource set and a CSI-SSB resource set.

FIG. 3 is a diagram to show an example of an RRC information element related to TCI state.

FIG. 4 FIGS. 4A and 4B are diagrams to show examples of a single-panel UL transmission.

FIG. 5 FIG. 5A to FIG. 5C are diagrams to show examples of simultaneous UL transmission using multiple panels.

FIG. 6 is an excerpt of an RRC information element “CSI-ReportConfig.”

FIG. 7 is a diagram to show an example of CSI report in Rel-15 NR.

FIG. 8 is a diagram to show an example of CSI report for multi-group-based beam reporting in NR of Rel. 17 or later versions.

FIG. 9 is a diagram to show an example of UL group-based beam reporting according to a first embodiment.

FIG. 10 is a diagram to show another example of the UL group-based beam reporting according to the first embodiment.

FIG. 11 is a diagram to show another example of the UL group-based beam reporting according to the first embodiment.

FIG. 12 is a diagram to show another example of the UL group-based beam reporting according to the first embodiment.

FIG. 13 is a diagram to show another example of the UL group-based beam reporting according to the first embodiment.

FIG. 14 is a diagram to show another example of the UL group-based beam reporting according to the first embodiment.

FIG. 15 is a diagram to show an example of UL group-based beam reporting according to a second embodiment.

FIG. 16 is a diagram to show another example of the UL group-based beam reporting according to the second embodiment.

FIG. 17 is a diagram to show another example of the UL group-based beam reporting according to the second embodiment.

FIG. 18 is a diagram to show another example of the UL group-based beam reporting according to the second embodiment.

FIG. 19 is a diagram to show an example of UL group-based beam reporting according to a third embodiment.

FIG. 20 is a diagram to show another example of the UL group-based beam reporting according to the third embodiment.

FIG. 21 is a diagram to show an example of a schematic structure of a radio communication system according to one embodiment.

FIG. 22 is a diagram to show an example of a structure of a base station according to one embodiment.

FIG. 23 is a diagram to show an example of a structure of a user terminal according to one embodiment.

FIG. 24 is a diagram to show an example of a hardware structure of the base station and the user terminal according to one embodiment.

FIG. 25 is a diagram to show an example of a vehicle according to one embodiment.

### DESCRIPTION OF EMBODIMENTS

### CSI

In NR, a UE measures a channel state by using a reference signal (or a resource for the reference signal) and feeds back (reports) channel state information (CSI) to a network (for example, a base station).

The UE may measure the channel state by using at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like.

A CSI-RS resource may include at least one of a non-zero power (NZP) CSI-RS resource, a zero power (ZP) CSI-RS resource, and a CSI interference measurement (CSI-IM) resource.

A resource for measuring a signal component for CSI may be referred to as a signal measurement resource (SMR) or a channel measurement resource (CMR). The SMR (CMR) may include, for example, the NZP CSI-RS resource, SSB, and the like for channel measurement.

A resource for measuring an interference component for CSI may be referred to as an interference measurement resource (IMR). The IMR may include, for example, at least one of an NZP CSI-RS resource, an SSB, a ZP CSI-RS resource, and a CSI-IM resource for interference measurement.

The SS/PBCH block is a block including a synchronization signal (for example, a primary synchronization signal (PSS), a secondary synchronization signal (SSS)) and a PBCH (and a corresponding DMRS), and may be referred to as an SS block (SSB) or the like.

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The CSI may have a plurality of parts. CSI part 1 may include information with a relatively small number of bits (for example, the RI). CSI part 2 may include information (for example, CQI) having a relatively large number of bits such as information determined based on CSI part 1.

The CSI may be classified into several CSI types. The type, size, and so on of information to report may differ depending on the CSI type. For example, a CSI type (also referred to as type 1 (type I) CSI, CSI for single beam, and the like) configured to perform communication using a single beam and a CSI type (also referred to as type 2 (type II) CSI, CSI for multi-beam, and the like) configured to perform communication using multiple beams may be defined. The usage of the CSI type is not limited to this.

As CSI feedback methods, periodic CSI (P-CSI) reporting, aperiodic CSI (A-CSI) reporting, semi-persistent CSI (SP-CSI) reporting and the like are under study.

The UE may be notified of CSI measurement configuration information by using higher layer signaling, physical layer signaling, or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

The CSI measurement configuration information may be configured using, for example, an RRC information element “CSI-MeasConfig.” The CSI measurement configuration information may include CSI resource configuration information (RRC information element “CSI-ResourceConfig”), CSI report configuration information (RRC information element “CSI-ReportConfig”), or the like. The CSI resource configuration information relates to resources for CSI measurement, and the CSI report configuration information relates to how the UE performs CSI reporting.

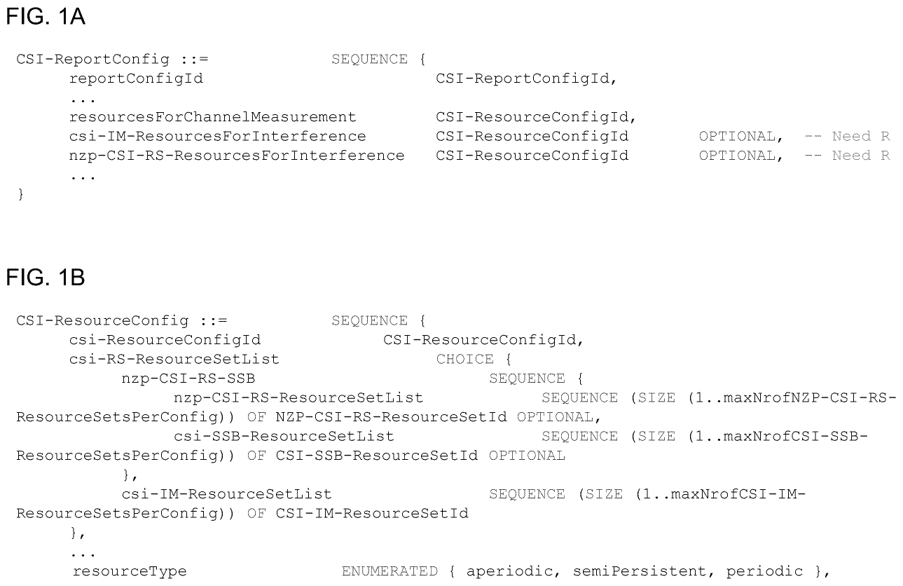

FIGS. 1A and 1B are diagrams to show examples of RRC information elements related to CSI report configuration and CSI resource configuration. In this example, an excerpt of a field (which may be referred to as a parameter) included in the information element is illustrated. FIGS. 1A and 1B are illustrated using Abstract Syntax Notation One (ASN. 1) notation. Note that the drawings related to other RRC information elements (or RRC parameters) of the present disclosure are also illustrated in the same notation.

As shown in FIG. 1A, the CSI report configuration information (“CSI-ReportConfig”) includes channel measurement resource information (“resourcesForChannelMeasurement”). The CSI report configuration information may also include interference measurement resource information (for example, NZP CSI-RS resource information for interference measurement (“nzp-CSI-RS-ResourcesForInterference”), CSI-IM resource information for interference measurement (“csi-IM-ResourcesForInterference”), and the like). These pieces of resource information correspond to identifiers (IDs) of CSI resource configuration information (“CSI ResourceConfigId”).

Note that one or more IDs of the CSI resource configuration information corresponding to each piece of resource information (which may be referred to as CSI resource configuration IDs) may have the same value, or may have different values.

As shown in FIG. 1B, the CSI resource configuration information (“CSI-ResourceConfig”) may include a CSI resource configuration information ID, CSI-RS resource set information (“csi-RS-ResourceSerList”), a resource type (“resourceType”), or the like. The CSI-RS resource set list may include at least one of information of NZP CSI-RS and SSB for measurement (“nzp-CSI-RS-SSB”) and CSI-IM resource set list information (“csi-IM-ResourceSetList”).

The resource type represents behavior of the resource configuration in the time domain, and “aperiodic”, “semi-persistent”, and “periodic” can be configured of the resource type. For example, the CSI-RSs corresponding to respective types may be referred to as an A-CSI-RS, an SP-CSI-RS, and a P-CSI-RS.

Note that the channel measurement resource may be used for calculation of, for example, CQI, PMI, L1-RSRP, or the like. The interference-measurement resource may be used for calculation of L1 SINR, L1 SNR, L1 RSRQ, and other interference-related indicators.

When interference measurement is performed with CSI-IM, each CSI-RS for channel measurement may be associated with a CSI-IM resource in terms of resources, based on the order of a CSI-RS resource and a CSI-IM resource in a corresponding resource set.

The “nzp-CSI-RS-SSB” may include NZP CSI-RS resource set list information (“nzp-CSI-RS-ResourceSetList”) and SSB resource set list information for CSI measurement (“csi-SSB-ResourceSetList”). Each of these pieces of list information correspond to one or more NZP CSI-RS resource set IDs (“NZP-CSI-RS-ResourceSetId”) and one or more CSI-SSB resource set IDs (“CSI-SSB-ResourceSetId”), and may be used to specify a measurement target resource.

The NZP CSI-RS resource set list information (“nzp-CSI-RS-ResourceSetList”) may include an NZP CSI-RS resource set ID(s) (“NZP-CSI-RS-ResourceSetId”), the number of which is the maximum number of NZP CSI-RS resource sets per CSI resource configuration (“maxNrofNZP-CSI-RS-ResourceSetsPerConfig”). The maximum number of NZP CSI-RS resource sets per CSI resource configuration (“maxNrofNZP-CSI-RS-ResourceSetsPerConfig”) may be up to 16 if the resource type is “aperiodic” and 1 otherwise (if the resource type is “semi-persistent” or “periodic”).

The SSB resource set list information for CSI measurement (“csi-SSB-ResourceSetList”) may include a CSI-SSB resource set ID(s) (“CSI-SSB-ResourceSetId”), the number of which is the maximum number of SSB resource sets for CSI measurement per CSI resource configuration (“maxNrofCSI-SSB-ResourceSetsPerConfig”). The maximum number of SSB resource sets for CSI measurement per CSI resource configuration (“maxNrofCSI-SSB-ResourceSetsPerConfig”) may be one.

The CSI-IM resource set list information (“csi-IM-ResourceSetList”) may include a CSI-IM resource set ID(s) (“CSI-IM-ResourceSetId”), the number of which is the maximum number of CSI-IM resource sets per CSI resource configuration (“maxNrofCSI-IM-ResourceSetsPerConfig”). The maximum number of CSI-IM resource sets per CSI resource configuration (“maxNrofCSI-IM-ResourceSetsPerConfig”) may be up to 16 if the resource type is “aperiodic” and 1 otherwise.

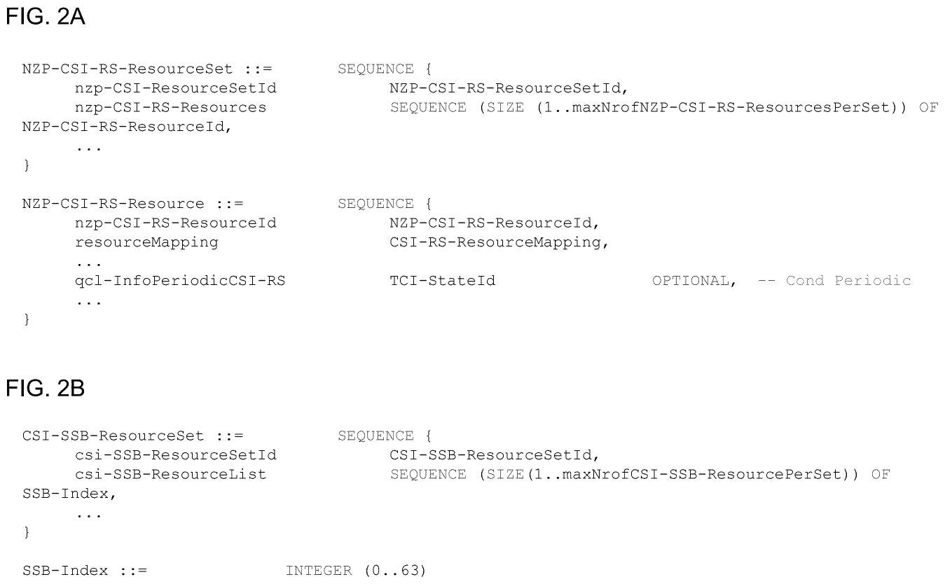

FIGS. 2A and 2B are diagrams to show examples of RRC information elements related to an NZP CSI-RS resource set and a CSI-SSB resource set.

As shown in 2A, the NZP CSI-RS ResourceSet information (“NZP-CSI-RS-ResourceSet”) includes an NZP CSI-RS ResourceSet ID and one or more NZP CSI-RS resource Ids (“NZP-CSI-RS-ResourceId”).

The NZP CSI-RS resource information (“NZP-CSI-RS-Resource”) may include an NZP CSI-RS resource ID and an ID (“TCI-stateId”) of a transmission configuration indication state (TCI state). The TCI state is described below.

As shown in 2B, CSI-SSB ResourceSet information (“CSI-SSB-ResourceSet”) includes a CSI-SSB resource set ID and one or more pieces of SSB index information (“SSB-Index”). The SSB index information is, for example, an integer of 0 to 63, and may be used to identify the SSB in an SS burst.

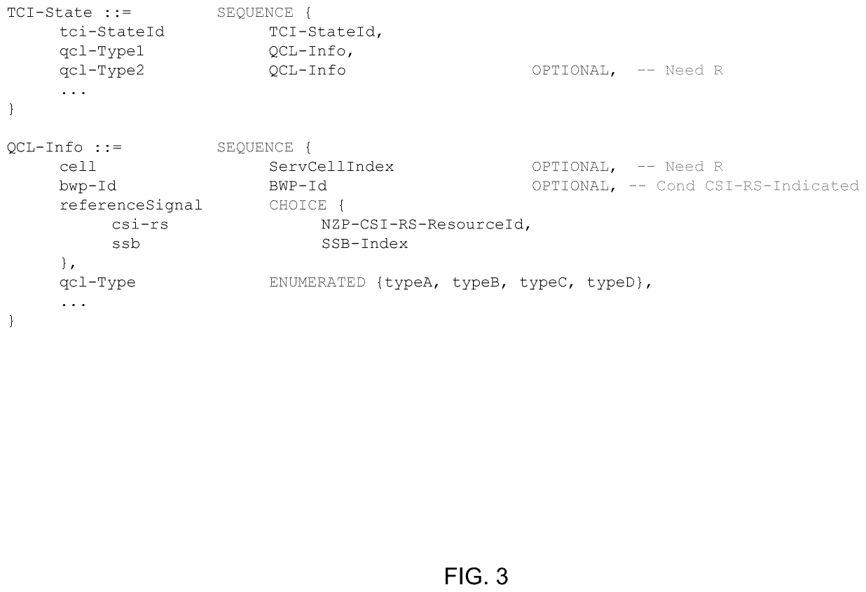

FIG. 3 is a diagram to show an example of an RRC information element related to TCI state.

The TCI state is information related to quasi-co-location (QCL) of a channel or signal, and may be referred to as a spatial reception parameter, spatial relation information (SRI), or the like. The TCI state may be configured or indicated for the UE for each channel or for each signal.

As shown in FIG. 3, the TCI state information (“TCI-State”) may include a TCI state ID and one or more pieces of QCL information (“QCL-Info”). The QCL information may include at least one of information (RS-related information (“referenceSignal”)) related to a reference signal of a QCL source and information (QCL type information (“qcl-Type”)) indicating a QCL type. The RS-related information may include information such as an index of the RS (e.g., NZP CSI-RS resource ID, SSB index), an index of a serving cell, an index of a BWP (Bandwidth Part) in which the RS is located.

The UE may control reception processing (for example, at least one of reception, demapping, demodulation, decoding, reception beam determination, and the like), transmission processing (for example, at least one of transmission, mapping, modulation, encoding, transmission beam determination, and the like), and the like for at least one of a signal and a channel (expressed as a signal/channel), based on the TCI state corresponding to the TCI state ID associated with the signal/channel.

As shown in 2A, for P-CSI-RS, a related TCI state may be configured by RRC. Note that, for the P-CSI-RS, the SP-CSI-RS and the A-CSI-RS, the related TCI state may be judged based on higher layer signaling, physical layer signaling or a combination thereof.

In Rel. 17/18 and later versions, it is assumed that UL transmission using a plurality of UE panels is supported.

### Single-Panel Transmission

At least one of the following transmission schemes A and B (single-panel UL transmission schemes A and B) may be applied to a single-panel UL transmission scheme or a single-panel UL transmission scheme candidate. In the present disclosure, a panel/UE panel may be interpreted as a UE capability value set reported for each UE capability.

### Transmission Scheme A: Single-Panel Single-TRP UL Transmission

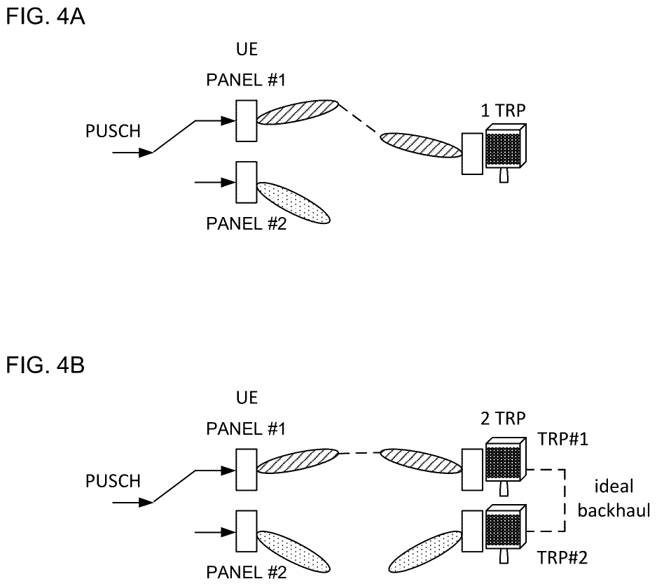

In Rel. 15 and Rel. 16, the UE uses a transmission scheme in which the UE transmits UL for one TRP at one time point from only one beam and panel (FIG. 4A).

### Transmission Scheme B: Single-Panel Multi-TRP UL Transmission

In Rel. 17, it is under study to perform UL transmission from only one beam and panel at one time point and perform repetition transmission to a plurality of TRPs (FIG. 4B). In the example of FIG. 4B, the UE transmits a PUSCH from panel #1 to TRP #1, and then (switches the beam and the panel and) transmits a PUSCH from panel #2 to TRP #2. The two TRPs are connected through an ideal backhaul.

### Multi-Panel Transmission

In Rel. 18 and later versions, in order to improve UL throughput/reliability, supporting simultaneous UL transmission using a plurality of panels (for example, simultaneous multi-panel UL transmission (SiMPUL)) toward one or more TRPs is under study. A multi-panel UL transmission scheme is under study for a given UL channel (for example, a PUSCH/PUCCH) or the like.

As multi-panel UL transmission, for example, up to X (for example, X=2) and up to Y (for example, Y=2) panels may be supported. In multi-panel UL transmission, when UL precoding indication for a PUSCH is supported, a codebook of an existing system (e.g., Rel. 16 or earlier versions) may be supported for multi-panel simultaneous transmission. In consideration of single DCI and multi-DCI based multi-TRP operation, the number of layers may be up to x (e.g., x=4) in all panels and the number of codewords (CWs) may be up to y (e.g., y=2) in all panels.

As the multi-panel UL transmission scheme or a multi-panel UL transmission scheme candidate, at least one of the following schemes 1 to 3 (multi-panel UL transmission schemes 1 to 3) is under study. Only one of the transmission schemes 1 to 3 may be supported. A plurality of schemes including at least one of the transmission schemes 1 to 3 are supported, and one of the plurality of transmission schemes may be configured for the UE.

### Transmission Scheme 1: Coherent Multi-Panel UL Transmission

A plurality of panels may be synchronized with each other. All layers are mapped to all panels. A plurality of analog beams are indicated. An SRS resource indicator (SRI) field may be extended. This scheme may use up to 4 layers for UL.

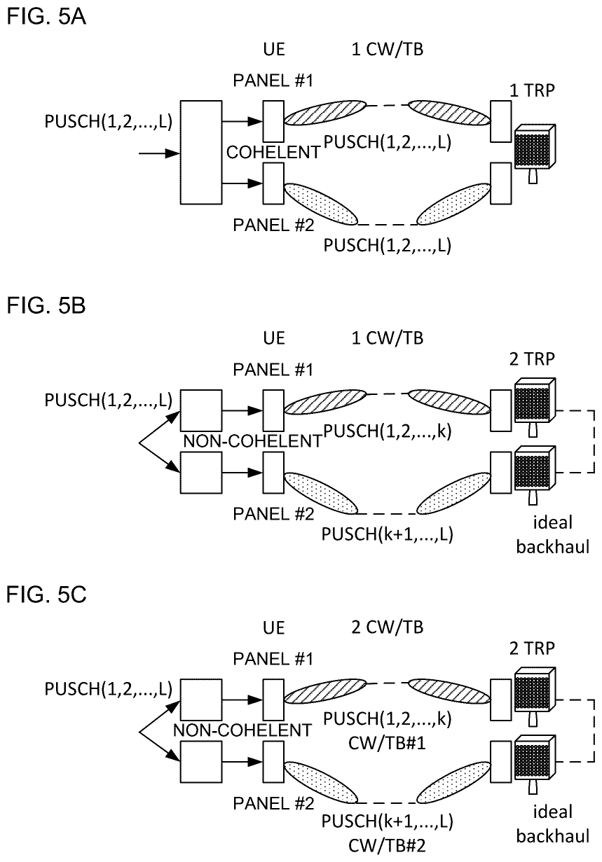

In an example of FIG. 5A, the UE maps one codeword (CW) or one transport block (TB) to L layers (PUSCH (1, 2, . . . , L)) and transmits the L layers from each of two panels. Panel #1 and Panel #2 are coherent. The transmission scheme 1 can obtain a gain due to diversity. The total number of layers in the two panels is 2L. When the maximum value of the total number of layers is 4, the maximum value of the number of layers in one panel is 2.

### Transmission Scheme 2: Non-Coherent Multi-Panel UL Transmission of One Codeword (CW) or Transport Block (TB)

The plurality of panels may not be synchronized. Different layers are mapped to different panels and one CW or TB for a PUSCH from a plurality of panels. A layer corresponding to the one CW or TB may be mapped to the plurality of panels. This transmission scheme may use up to 4 layers or up to 8 layers for UL. When up to 8 layers are supported, this transmission scheme may support one CW or TB using up to 8 layers.

In an example of FIG. 5B, the UE maps one CW or one TB to k layers (PUSCH (1, 2, . . . , k)) and (L−k) layers (PUSCH (k+1, k+2, L)), transmits the k layers from panel #1, and transmits the (L−k) layers from panel #2. The transmission scheme 2 can obtain a gain due to multiplexing and diversity. The total number of layers in the two panels is L.

### Transmission Scheme 3: Non-Coherent Multi-Panel UL Transmission of Two CWs or TBs

The plurality of panels may not be synchronized. Different layers are mapped to different panels and two CWs or TBs for PUSCHs from a plurality of panels. A layer corresponding to one CW or TB may be mapped to one panel. Layers corresponding to a plurality of CWs or TBs may be mapped to different panels. This transmission scheme may use up to 4 layers or up to 8 layers for UL. When up to 8 layers are supported, this transmission scheme may support up to 4 layers per CW or TB.

In an example of FIG. 5C, the UE maps CW #1 or TB #1 to k layers (PUSCH (1, 2, . . . k)) and maps CW #2 or TB #2 to (L−k) layers (PUSCH (k+1, k+2, . . . , L)) in 2 CWs or 2 TBs, and transmits the k layers from panel #1 and the (L−k) layers from panel #2. The transmission scheme 3 can obtain a gain due to multiplexing and diversity. The total number of layers in the two panels is L.

In each of the above-described transmission schemes, the base station may configure or indicate panel-specific transmission for UL transmission by using UL TCI or a panel ID. The UL TCI (UL TCI state) may be based on signaling similar to a DL beam indication supported in Rel. 15. The panel ID may be implicitly or explicitly applied to transmission of at least one of a target RS resource or a target RS resource set, a PUCCH, an SRS, and a PRACH. When the panel ID is explicitly notified, the panel ID may be configured in at least one of a target RS, a target channel, and a reference RS (for example, a DL RS resource configuration or spatial relationship information).

In one or more transmission schemes/modes described above, multi-panel UL transmission (for example, simultaneous multi-panel UL transmission (SiMPUL)) for scheduling of a PUSCH based on one DCI (single-DCI)/scheduling of a PUSCH based on a plurality of pieces of DCI (multi DCI) is under study.

### UE Capability Value Set

In Rel-17 NR and later versions, reporting a list of UE capability value sets in a UE capability report is supported. The UE capability value set may mean a panel supported/used by the UE. The UE capability value set may be interpreted as a UE capability value.

Each UE capability value set in Rel. 17 may be configured based on the maximum number of SRS ports supported. For example, when the maximum number of SRS ports is X, the UE reports X (e.g., X=4) UE capability value sets.

Reporting the list of UE capability value sets by the UE enables UE-initiated panel activation and selection. The correspondence between a reported CSI-RS/SSB resource index (CRI/SSBRI) and one of the UE capability value sets in the reported list may be determined by the UE and informed to the NW in a beam reporting instance.

In Rel-17 NR and later versions, it is supported that the UE reports the list of UE capability value sets to facilitate UE-initiated panel activation and selection. Each UE capability value set included in the list is configured with the maximum number of supported SRS ports, and any two UE capability value sets may be configured differently (or separately). The UE capability value set may be configured in common to a plurality of (or all) BWPs/CCs in the same band, or may be configured in common to a plurality of (or all) BWPs/CCs in the same band combination (BC).

Each UE capability value set in Rel. 17 is configured with the maximum number of supported SRS ports. In Rel. 18 and later versions, the UE capability value set may include, in addition to (or instead of) the maximum number of supported SRS ports, at least one of the maximum UL rank, the maximum number of beams, the maximum number of SRS resource sets, the maximum number of SRS resources, the maximum number of SRS resources per set, EIRP, and transmission-power-related capability.

When a plurality of (e.g., two) UE capability value sets are configured differently, this may mean that any two capability value sets have different maximum numbers of supported SRS port.

Note that the plurality of (for example, two) UE capability value sets may have the same capability. For example, two UE capability value sets may have the same maximum number of supported SRS ports. In this case, the two UE capability value sets having the same maximum number of supported SRS ports may be configured differently in other parameters (e.g., EIRP).

### Beam Management

In Rel-15 NR, a method of beam management (BM) has been studied. In such beam management, beam selection is performed based on L1-RSRP reported by the UE. Changing (switching) a beam of a given signal/channel may correspond to changing at least one of the TCI state and the QCL assumption of the signal/channel.

The UE may report (transmit) the measurement result for beam management by using an uplink control channel (Physical Uplink Control Channel (PUCCH)) or an uplink shared channel (Physical Uplink Shared Channel (PUSCH)). The measurement result may be, for example, CSI including at least one of L1-RSRP, L1-RSRQ, L1-SINR, L1-SNR, and the like.

The measurement result (for example, CSI) reported for beam management may be referred to as beam measurement, a beam measurement report, a beam report, beam report CSI, or the like.

The CSI measurement for the beam report may include interference measurement. The UE may measure channel quality, interference, or the like by using a resource for CSI measurement, and derive the beam report.

The beam report may include at least one of the result of the channel quality measurement and the result of the interference measurement. The result of the channel-quality measurement may include, for example, L1-RSRP. The result of the interfering measurement may include L1-SINR, L1-SNR, L1-RSRQ, other interference-related indicators (e.g., any indicator other than L1 RSRP), and the like.

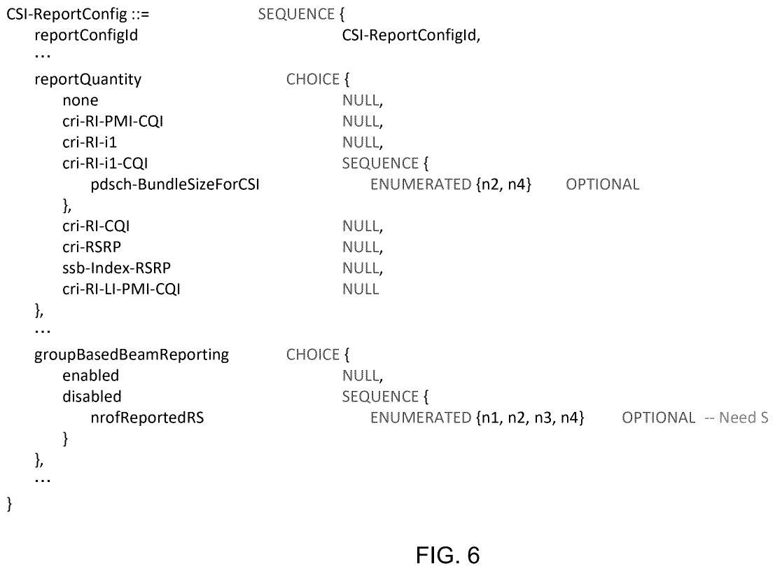

CSI reporting may be performed based on a CSI report configuration configured by a higher layer parameter. FIG. 6 is an example of an RRC information element “CSI-ReportConfig” in Rel. 16. In FIG. 6, another part of the same CSI report configuration information (CSI-ReportConfig) as that in FIG. 1A is extracted.

The CSI report configuration information may include a “report quantity” (which may be represented by an RRC parameter “reportQuantity”) which is information of a parameter to be reported in one report instance (for example, one piece of CSI). The report quantity is defined by a type of ASN. 1 object called “choice”. Therefore, one of parameters (cri-RSRP, ssb-Index-RSRP, and the like) defined as the report quantity is configured.

The UE configured with a higher layer parameter (for example, an RRC parameter “groupBasedBeamReporting” related to the group-based beam reporting) included in the CSI report configuration information being disabled may include, in the beam report (one report instance), beam measurement resource IDs (for example, SSBRI and CRI) having different numbers of higher layer parameters (for example, an RRC parameter “nrofReportedRS” indicating the number of reported RSs) included in the CSI report configuration information and the measurement results (for example, L1-RSRP) corresponding to the respective IDs.

A UE configured with groupBasedBeamReporting enabled reports CRI/SSBRI (e.g., CRI/SSBRI of one group) on a group-by-group basis for each report configuration. The group includes a plurality of (for example, two) CRIs/SSBRI. This may mean that a plurality of (e.g., two) CRIs/SSBRI are simultaneously received by the UE.

For example, the UE in which groupBasedBeamReporting is configured to be enabled may include two different beam measurement resource IDs (for example, CRI/SSBRI) and two measurement results (for example, L1-RSRP) corresponding to the respective IDs in the beam report for each report configuration. The two beam measurement resources (CSI-RS resource and SSB resource) may be simultaneously received by the UE using one spatial domain reception filter or may be simultaneously received by the UE using a plurality of simultaneous spatial domain reception filters.

The NZP CSI-RS resource set information shown in FIG. 2A may include information related to repetition of resources in the resource set. The information related to repetition may indicate, for example, “on” or “off.” Note that, ‘on’ may be represented as ‘enabled or valid’, and ‘off’ may be represented as ‘disabled or invalid’.

For example, for a resource set for which repetition is configured to be ‘on’, the UE may assume that the resources in the resource set have been transmitted using the same downlink spatial domain transmission filter. In this case, the UE may assume that the resources in the resource set have been transmitted using the same beam (for example, using the same beam from the same base station).

For a resource set for which repetition is configured to be ‘off’, the UE may perform control such that the UE is prohibited to assume (or need not assume) that resources in the resource set have been transmitted using the same downlink spatial domain transmission filter. In this case, the UE may assume that the resources in the resource set are not transmitted using the same beam (have been transmitted using different beams). In other words, for a resource set for which repetition is configured to be ‘off’, the UE may assume that the base station performs beam sweeping.

In Rel-15 NR, among the report quantity, cri-RSRP and ssb-Index-RSRP are related to beam management. The UE configured with cri-RSRP as the report quantity reports the CRI and the L1-RSRP corresponding to the CRI. The UE configured with ssb-Index-RSRP as the report quantity reports SSBRI and L1 RSRP corresponding to the SSBRI.

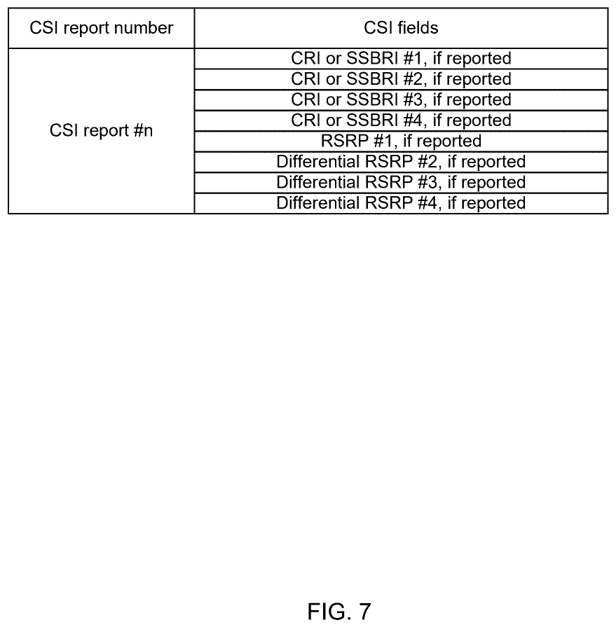

FIG. 7 is a diagram to show an example of CSI report in Rel-15 NR. FIG. 7 shows a mapping order of CSI fields included in one CSI report (n-th CSI report #n) for CSI/RSRP or SSBRI/RSRP reporting, which is defined in Rel. 15.

The CSI report in FIG. 7 may include one or more sets of CRI/SSBRI and RSRP. The number of these sets may be configured by a higher layer parameter (e.g., RRC parameter “nrofReportedRS”) indicating the number of reference signal resources to be reported.

For L1-RSRP reporting, when nrofReportedRS is configured to 1 (‘n1’ as a value), RSRP #1 which is a field of a given number of bits (e.g., m bits) indicating the largest measured value of L1-RSRP is included in the CSI report. For Rel-15 NR, m=7.

For L1-RSRP reporting, when nrofReportedRS is configured to be greater than 1 or when groupBasedBeamReporting is configured to be enabled, the UE utilizes differential L1-RSRP based reporting. To be more specific, the UE includes RSRP #1 indicating the L1-RSRP of the largest measurement value and differential RSRP #k calculated for the k-th (k=2, 3, 4 in FIG. 7) largest L1-RSRP by referring to the largest measurement value (for example, as a difference from the measurement value), in the same CSI report (reporting instance). Here, the difference RSRP #k may be a field of bits (for example, n bits) smaller than the given number. For Rel-15 NR, n=4.

For example, for each group, an absolute RSRP value of 7 bits (ranging from −140 dB to −44 dB using a 1-dBm step size) for the first beam and a differential RSRP value of 4 bits for the second beam are reported.

Note that, when groupBasedBeamReporting is configured to be enabled, the UE includes RSRP #1 and differential RSRP #2 in the same CSI report.

The CRI/SSBRI #k in FIG. 7 is a field indicating the CRI/SSBRI corresponding to RSRP #k or differential RSRP #k (included when RSRP #k or differential RSRP #k is reported).

In NR of Rel. 16 or later versions, nrofReportedRS may be a value of 4 or more, or may be 4 or more. The CSI report may include four more sets of CRI/SSBRI and RSRP. The above-described m, n, and the like are not limited to 7 and 4, respectively.

In NR of Rel. 16 or later versions, L1 SINR reporting may be performed. The contents of the RSRP in the above-described L1 RSRP reporting replaced with the SINR may be applied to the L1-SINR reporting. In this case, the configuration/parameter for the SINR may be different from the configuration/parameter for the RSRP, and for example, the nrofReportedRS described above may be interpreted as nrofReportedRSForSINR indicating the number of reference signal resources of the report target of the SINR.

For L1-RSRP computation, the UE may be configured with CSI-RS resource settings of up to 16 CSI-RS resource sets, including up to 64 resources in each resource set. The total number of CSI-RS resources that are different over all resource sets may be less than or equal to 128.

For the computation of L1-SINR, for channel measurement, the UE may be configured with CSI-RS resource settings of up to 16 CSI-RS resource sets, including up to 64 CSI-RS resources or up to 64 SS/PBCH blocks in total.

For the UE configured with information of aperiodic trigger state list of the CSI (higher layer parameter “CSI-AperiodicTriggerStateList”), when one resource setting linked to CSI-ReportConfig has a plurality of aperiodic resource sets, only one of the aperiodic CSI-RS resources of the resource setting may be associated with a trigger state. In this case, the UE may be configured by a higher layer for each resource setting in each trigger state so as to select one CSI-IM/NZP CSI-RS resource set from the resource setting.

The UE may not expect or assume that at least one of the NZP CSI-RS resource and the SS/PBCH block resource exceeding 64 is configured in the channel measurement resource setting of CSI-ReportConfig in which the report quantity (higher layer parameter reportQuantity) is configured to “none”, “cri-RI-CQI”, “cri-RSRP”, “ssb-Index-RSRP”, “cri-SINR”, or “ssb-Index-SINR”.

When the UE is configured with CSI-ReportConfig in which the reporting quantity (higher layer parameter reportQuantity) is configured to “cri-RSRP”, “cri-SINR” or “none” and CSI-ReportConfig is linked to a resource setting in which the higher layer parameter resourceType is configured to “aperiodic”, the UE may not assume that more than 16 CSI-RS resources are configured in the CSI-RS resource set included in the resource setting.

When CSI-ReportConfig in which the report quantity (higher layer parameter reportQuantity) is configured to “cri-RSRP”, “cri-RI-PMI-CQI”, “cri-RI-il”, “cri-RI-i1-CQI”, “cri-RI-CQI”, “cri-RI-LI-PMI-CQI” or “cri-SINR” is configured in the UE, and two or more resources for channel measurement are configured in the corresponding resource set, the UE may derive a CSI parameter other than the CRI on the condition of the reported CRI. Here, CRI k (k≥0) may correspond to the configured (k+1)-th entry of the associated nzp-CSI-RS-Resources in the corresponding NZP-CSI-RS-ResourceSet for channel measurement and the (k+1)-th entry of the associated csi-IM-Resource in the csi-IM-ResourceSet or the (k+1)-th entry of the associated nzp-CSI-RS-Resources in the corresponding NZP-CSI-RS-ResourceSet for interference measurement (when reportQuantity is configured to “cri-SINR” in CSI-ReportConfig). When two CSI-RS resources are configured, each resource may include up to 16 CSI-RS ports. When three or more and eight or less CSI-RS resources are configured, each resource may include up to 8 CSI-RS ports.

When CSI-ReportConfig in which the report quantity (higher layer parameter reportQuantity) is configured to “ssb-Index-RSRP” is configured in the UE, the UE may report the SSBRI. Here, SSBRI k (k≥0) may correspond to the (k+1)-th entry configured in the associated csi-SSB-ResourceList in the corresponding CSI-SSB-ResourceSet.

When CSI-ReportConfig in which the report quantity (higher layer parameter reportQuantity) is configured to “ssb-Index-SINR” is configured in the UE, the L1-SINR may be derived on condition of the reported SSBRI. Here, SSBRI k (k≥0) may correspond to the configured (k+1)-th entry of the associated csi-SSB-ResourceList in the corresponding CSI-SSB-ResourceSet for channel measurement, and the (k+1)-th entry of the associated csi-IM-Resource in csi-IM-ResourceSet or the (k+1)-th entry of the associated nzp-CSI-RS-Resources in the corresponding NZP-CSI-RS-ResourceSet for interferer measurement.

### Extended Group-Based Beam Reporting

For future radio communication systems (for example, Rel. 17 and later versions), beam management-related enhancements (for example, beam reports suitable for a plurality of transmission/reception points (TRPs), which may be referred to as enhanced group-based beam reporting) for a user terminal (User Equipment (UE)) having a plurality of panels (multiple panels), a plurality of TRPs, and the like are under study.

The above-described groupBasedBeamReporting is suitable for a case where multi-TRP transmission, multi-panel reception, and the like are applied, because one group including a plurality of (for example, two) CRIS/SSBRIs can be reported by one report. For example, the best beam in TRP1 can be used to report RSRP #1 and the best beam in TRP2 can be used to report differential RSRP #2.

In Rel. 15 and Rel. 16, the UE configured with group-based beam reporting to be enabled can report only one group with two different CRIs/SSBRIs (which may be read as beam index) for each reporting configuration. Therefore, it is assumed that the number of groups that can be reported by group-based beam reporting is expanded for Rel. 17.

For example, two resource sets (e. g., CMR sets) for channel measurement may be configured/triggered to be aperiodic/semi-persistent/aperiodic resource type. The two resource sets for channel measurement (e.g., CMR sets) may be, for example, two CSI-SSB resource sets/two NZP-CSI-RS-resource sets. The UE may be configured to be able to report up to four CRI/SSBRI groups. Note that the number of groups that can be reported (or the number of candidates 1/2/3/4) may be configured by a higher layer parameter.

Each group may have a plurality of (e.g., two) CRIS/SSBRIS, and the CRIS/SSBRIs of each group may be selected from two CSI resource sets for report configuration. The two CRIS/SSBRIS of each group may mean that the UE is capable of receiving simultaneously (e.g., receiving simultaneously using one spatial domain reception filter).

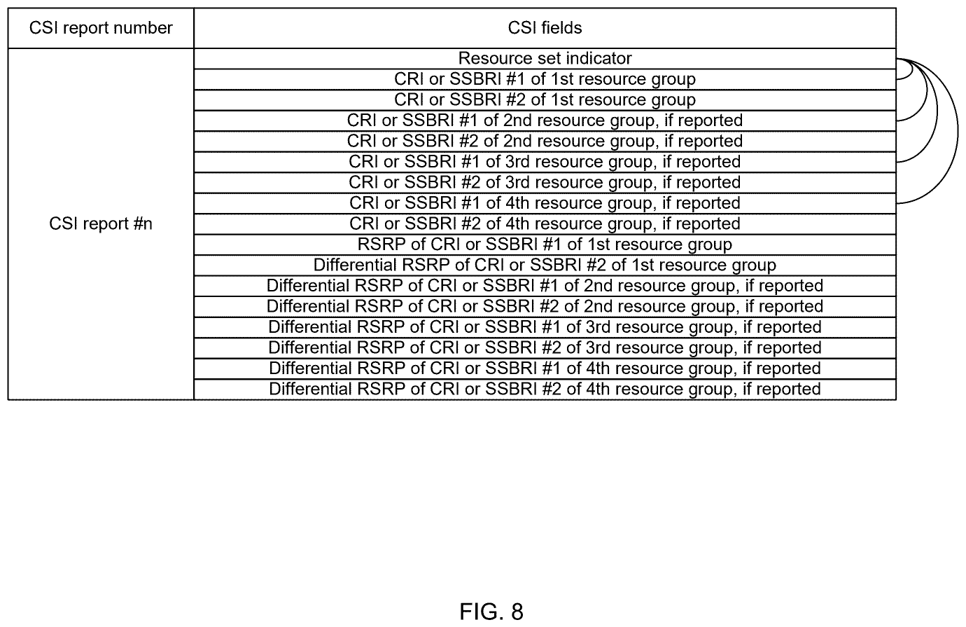

FIG. 8 is a diagram to show an example of a CSI report when the extended group-based beam reporting is performed. FIG. 8 shows a mapping order of CSI fields included in one report (e. g., n-th CSI report #n) for group-based CSI/RSRP or SSBRI/RSRP reporting.

The CSI report may include up to X (for example, X=4) resource groups. Each group includes a plurality of (for example, two) CRIS/SSBRIS. Here, a case is shown where CRI or SSBRI #1 and CRI or SSBRI #2 are reported as each resource group.

A resource set indicator (e.g., Resource set indicator) may be included in the CSI field. The channel measurement resource set in which the CRI or SSBRI #1 of the first resource group is reported may be indicated by the value of the resource set indicator. For example, a 1-bit resource set indicator having a value of 0 or 1 may indicate the first or second channel measurement resource set, respectively, and the CRI or SSBRI #1 of the first resource group may be reported therefrom. All remaining resource groups (e.g., when there are other resource groups to be reported) follow the same mapping order as the first resource group. For example, the CRI or SSBRI #1 of all the remaining resource groups may be reported (or selected) from the channel measurement resource set indicated by the resource set indicator.

In other words, the CRI or SSBRI #1 of each group may be reported (or selected) from a resource set indicated by the resource set indicator (e. g., Resource set indicator), and the CRI or SSBRI #2 may be reported (or selected) from another resource set. In this way, in all resource groups, the CRI or SSBRI #1 and the CRI or SSBRI #2 may be reported from different channel measurement resource sets.

The RSRP corresponding to the beam index (for example, the CRI or the SSBRI) of each resource group is reported. For example, the RSRP of the CRI or SSBRI of a specific group may be reported, and the difference between the CRI or SSBRI of the specific group and RSRP of for other RSRP may be reported. The RSRP of the CRI or SSBRI of the specific group may be the RSRP of the CRI or SSBRI #1 of the first resource group.

The extended group-based beam reporting may be configured (or configured to be enabled/activated) by a given higher layer parameter (e.g., groupBasedBeamReporting-r17). Alternatively, the extended group-based beam reporting may be judged to be enabled when a higher layer parameter (for example, nrofReportedGroups-r17) related to the number of groups to be reported is configured.

As described above, for Rel. 18 and later versions, it is under study to support simultaneous UL transmission (for example, simultaneous multi-panel UL transmission (SiMPUL)) using a plurality of panels to one or more TRPs (for example, multi-TRP).

In the group-based beam reporting of Rel. 15/16/17, the UE can indicate that two CRIS/SSBRIs of each group can be received simultaneously by the UE by reporting the group of CRIS/SSBRIS. In the present disclosure, the reporting may be referred to as DL group-based beam reporting.

For simultaneous multi-panel UL transmission in Rel. 18 and later versions, the UE needs to report whether the UE can transmit two beams simultaneously. Accordingly, the base station can recognize which beam is indicated/used for the simultaneous multi-panel UL transmission. For example, the UE may indicate, in the beam group report, that two beams (or beam indices) of each group can be transmitted simultaneously by the UE. In the present disclosure, the reporting may be referred to as UL group-based beam reporting. The same mechanism as the group-based beam reporting supported in Rel. 15/16/17 may be applied to the UL group-based beam reporting.

When the UL group-based beam reporting is performed, a problem is how to perform the reporting. For example, a problem is how to control the relationship (for example, a reporting method) between the UL group-based beam reporting and the DL group-based beam reporting.

More specifically, a problem is whether the UL group-based beam report is reported together with the DL group beam report or reported separately. Alternatively, a problem is how to configure/enable/activate the UL group-based beam reporting.

The present inventors have focused on the introduction/support of the UL group-based beam reporting, studied a method of controlling the UL group-based beam reporting, and came up with the idea of the present embodiment.

Embodiments according to the present disclosure will be described in detail with reference to the drawings as follows. The radio communication methods according to respective embodiments may each be employed individually, or may be employed in combination.

In the present disclosure, “A/B”, “at least one of A and B” and “A and B” may be interchangeably interpreted. In the present disclosure, “A/B/C”, “at least one of A, B, and C”, and “A, B and C” may be interchangeably interpreted.

In the present disclosure, a cell, a serving cell, a CC, a carrier, a BWP, a DL BWP, a UL BWP, an active DL BWP, an active UL BWP, and a band may be interchangeably interpreted.

In the present disclosure, an index, an ID, an indicator, and a resource ID may be interchangeably interpreted.

In the present disclosure, “support,” “control,” “controllable,” “operate,” and “operable” may be interchangeably interpreted.

Note that, in the present disclosure, a panel (reception panel), an Uplink (UL) transmission entity, a TRP, a spatial relation, a control resource set (CORESET), a PDSCH, a codeword, a base station, an antenna port (for example, a demodulation reference signal (DMRS) port), an antenna port group (for example, a DMRS port group), a group (for example, a code division multiplexing (CDM) group, a reference signal group, or a CORESET group, and a CORESET pool), a reference signal configuration, a reference signal set configuration, and the like may be interchangeably interpreted.

A panel Identifier (ID) and a panel may be interchangeably interpreted. A TRP ID and a TRP may be interchangeably interpreted.

In the present disclosure, a group, a set, a cluster, a panel, a group related to a (reported) beam, and the like may be interchangeably interpreted.

In the following embodiments, a beam index/beam ID may be interpreted as, for example, CRI/SSBRI. RSRP/SINR may be interpreted as any beam-related measurement result.

A name related to a CSI-RS may be interpreted as a corresponding name related to an SSB. For example, a CSI-RS resource may be interpreted as an SSB resource. In other words, a CSI-RS may be interpreted as a CSI-RS/SSB, and a CRI may be interpreted as a CRI/SSBRI.

In the present disclosure, a “reception panel” may correspond to at least one of an RS group, a TRP index, a CORESET pool index, an RS group configured for group-based beam reporting, a TCI state (or TCI) group, a QCL assumption (or QCL) group, and a beam group.

In the present disclosure, “at the same position” may be interpreted as “at the same i-th”, “corresponding to the same TRP”, or the like. Note that, in the present disclosure, “i-th” may mean that one is included in the i-th position in the CSI report or may mean that one is included in the i-th position in a group of the CSI report.

In the present disclosure, a “set”, a “CMR set”, a “CMR resource set”, and the like may be interchangeably interpreted. In the present disclosure, an “SSBRI/CRI” and a “CMR index” may be interchangeably interpreted. In the present disclosure, “RSRP/SINR” may be interchangeably interpreted as “L1-RSRP/L1-SINR/L3-RSRP/L3-SINR.” Note that L3 may mean Layer 3.

### Radio Communication Method

The UE may perform a group-based beam reporting (hereinafter, also referred to as UL group-based beam reporting) related to UL transmission in CSI reporting. The UL group-based beam reporting may be performed in the CSI report #n (for example, one report instance) common to the DL group-based beam reporting, or may be performed in a CSI report different from the DL group-based beam reporting.

The UE may receive information related to a CSI resource set that includes one or more (e.g., a plurality of) CRIS/SSBRIS. The UE may perform measurement on the CSI-RS/SSB resource included in the CSI resource set and corresponding to the CRI/SSBRI, and report the measurement result (for example, the CRI/SSBRI) as a group-based beam report.

The UE receives at least one of information related to a CSI resource set (or CRI/SSBRI) used for DL group-based beam reporting and information related to a CSI resource set (or CRI/SSBRI) used for UL group-based beam reporting. The information may be configured for the UE by a given higher layer parameter.

The CSI resource set (or CRI/SSBRI) used for the UL group-based beam reporting may be configured in common with the CSI resource set (or CRI/SSBRI) used for the DL group-based beam reporting. Alternatively, the CSI resource set (or CRI/SSBRI) used for the UL group-based beam reporting may be configured separately from the CSI resource set (or CRI/SSBRI) used for the DL group-based beam reporting.

### First Embodiment

In a first embodiment, an example of the group-based beam reporting related to UL transmission is described.

The UE may perform the UL group-based beam reporting in common with the DL group-based beam reporting. For example, the UE may report a common beam group (for example, a common group(s) of beams) for the DL group-based beam reporting (for example, a DL group-based beam report) and the UL group-based beam reporting (for example, a UL group-based beam report). In the present disclosure, a group, a beam group, and a resource group may be interchangeably interpreted.

For each group, the UE can simultaneously receive (or supports simultaneous reception of) a beam group (a plurality of beam indices included in the same group), and can simultaneously transmit (or supports simultaneous transmission of) a beam group (a plurality of beam indices included in the same group).

The UE may perform the UL group-based beam reporting by using at least one of the following option 1-1 to option 1-4.

### Option 1-1

The UE may report a plurality of (e.g., two) CRIS/SSBRIS (one group) in one reporting instance (e.g., a single reporting instance). The UE may be able to receive (or support reception of) two CRI-RS/SSB resources simultaneously and may be able to transmit (or support transmission of) two CSI-RS/SSB resources simultaneously.

The UE being capable of transmitting two CSI-RS/SSB resources simultaneously may mean that the UE can transmit two UL transmissions simultaneously (or supports simultaneous transmission), where a spatial relationship is associated with the two CSI-RS/SSB resources. In other words, the UE may support simultaneous transmission of two UL transmissions having a spatial relationship (or TCI state/quasi co-location/UL resource) associated with two CSI-RS/SSB resources included in the same group.

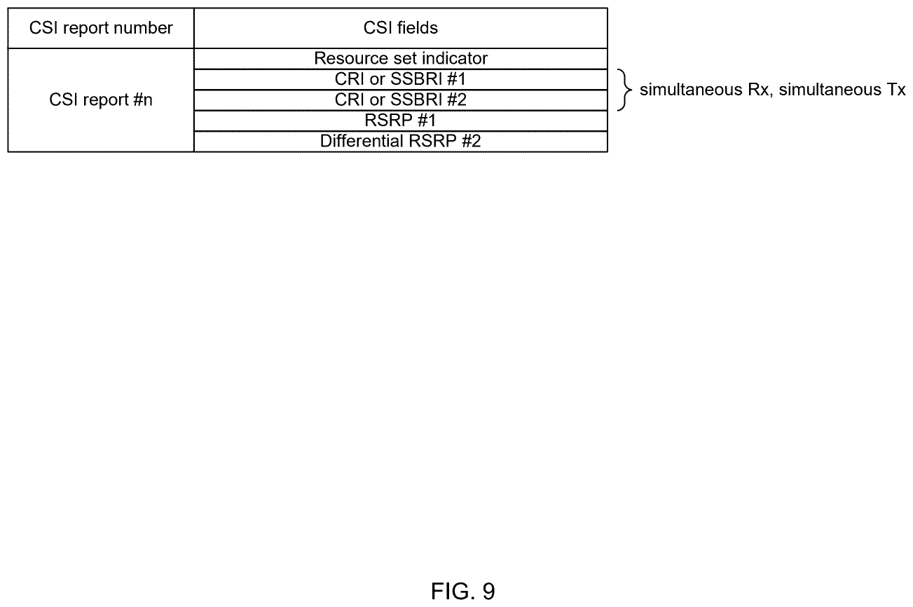

FIG. 9 is a diagram to show an example of a CSI report when a DL group-based beam reporting and a UL group-based beam reporting are performed in common. FIG. 9 shows a mapping order of CSI fields included in one report (e.g., n-th CSI report #n) for group-based CSI/RSRP or SSBRI/RSRP reporting.

Note that, in the CSI report described below, the order of the fields may be changed as appropriate. In the CSI report described below, RSRP may be interpreted as an SINR. When one CSI-RS resource set (for example, a single CSI-RS resource set) is configured for the CSI report illustrated in the following description, a resource set indicator field may not be included.

Here, a case is illustrated where CRI/SSBRI #1 and CRI/SSBRI #2 (one group) are reported as the group-based beam report. This case may mean that the UE can simultaneously receive CRI/SSBRI #1 and CRI/SSBRI #2 included in the same group and simultaneously transmit two UL transmissions associated with CRI/SSBRI #1 and CRI/SSBRI #2 included in the same group. In the present disclosure, a CRI/SSBRI may be interpreted as a CSI-RS/SSB resource.

### Option 1-2

The UE may report a plurality of (e.g., two) CRIS/SSBRIS of N groups in one reporting instance (e.g., a single reporting instance). In this case, the UE may be able to simultaneously receive (or support reception of) the two CSI-RS/SSB resources of each group and may simultaneously transmit (or support transmission of) the two CSI-RS/SSB resources of each group.

The number of groups (for example, N) may be defined in advance in specifications, or may be configured by a higher layer parameter (for example, nrofReportedRSgroup) related to the number of groups. Note that, in a case of N=1, option 1-1 may be applied.

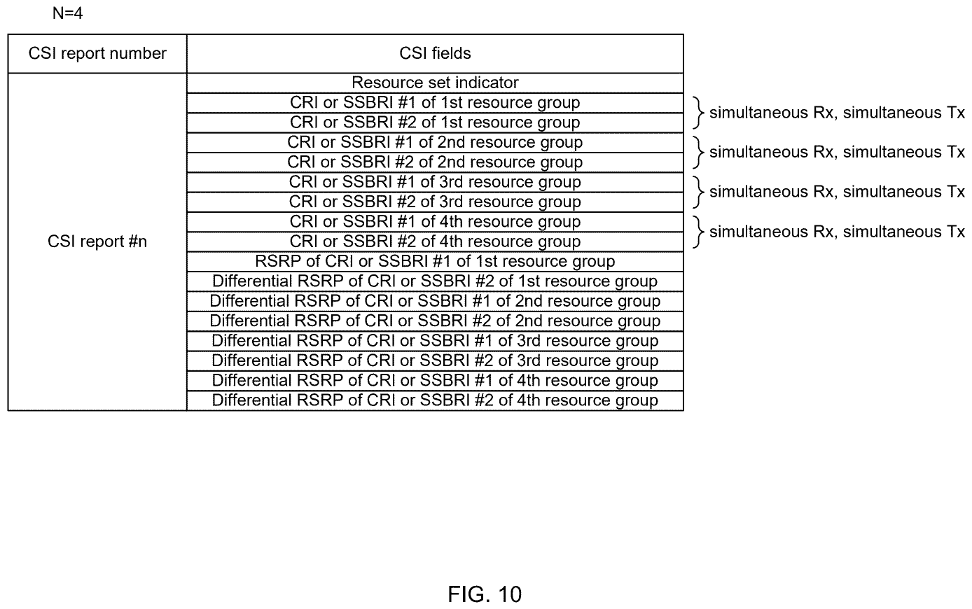

FIG. 10 is a diagram to show an example of a CSI report when DL group-based beam reporting and UL group-based beam reporting are performed in common. FIG. 10 shows a case where CRI/SSBRI (here, CRI/SSBRI #1 and CRI/SSBRI #2) of N (here, N=4) resource groups are reported.

This case may mean that the UE can simultaneously receive CRI/SSBRI #1 and CRI/SSBRI #2 included in the same group and simultaneously transmit two UL transmissions associated with CRI/SSBRI #1 and CRI/SSBRI #2 included in the same group.

### Option 1-3

The UE may report a plurality of (e.g., two) CRIS/SSBRIS of N groups in one reporting instance (e.g., a single reporting instance). In this case, the UE may be able to simultaneously receive two CSI-RS/SSB resources of each group (e.g., every N groups) and may be able to simultaneously transmit two CSI-RS/SSB resources of each group for M out of N groups (N≥M or N>M.

The number of groups (for example, at least one of N and M) may be defined in advance in specifications, or may be configured by a higher layer parameter (for example, nrofReportedRSgroup) related to the number of groups.

### Option 1-3-1

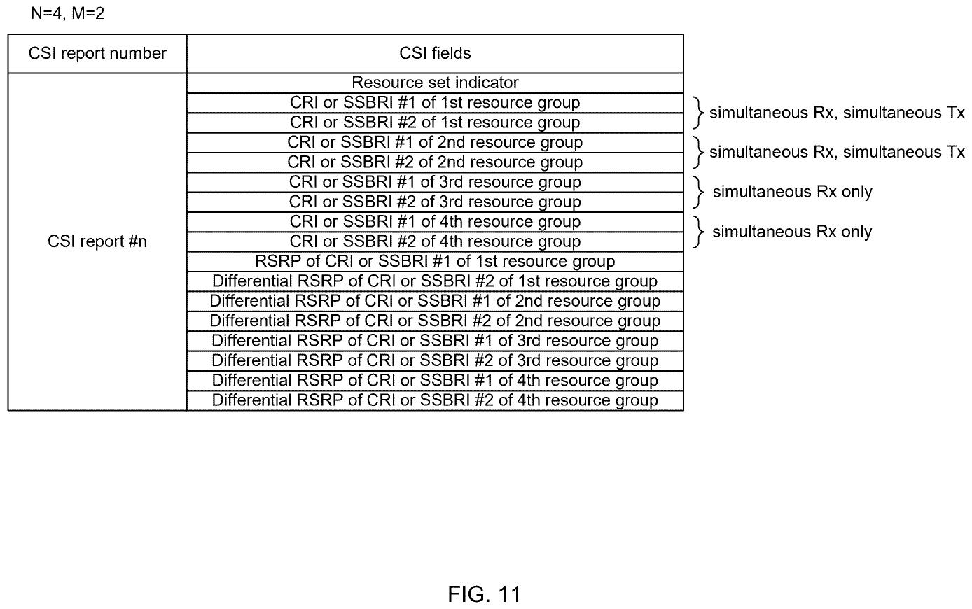

For the first/last M groups of the N groups, the UE may be allowed to transmit the CSI-RS/SSB resources of each group simultaneously (see FIG. 11).

FIG. 11 shows a case in which the UL group-based beam reporting and the DL group-based beam reporting are performed in common for the first two groups among the four groups (N=4, M=2). In this case, the UE may indicate for the first two of the four groups that the UE can transmit the CSI-RS/SSB resources of each group simultaneously. The other groups may support only the DL group-based beam reporting.

Option 1-3-1 may be a default action/default configuration.

### Option 1-3-2

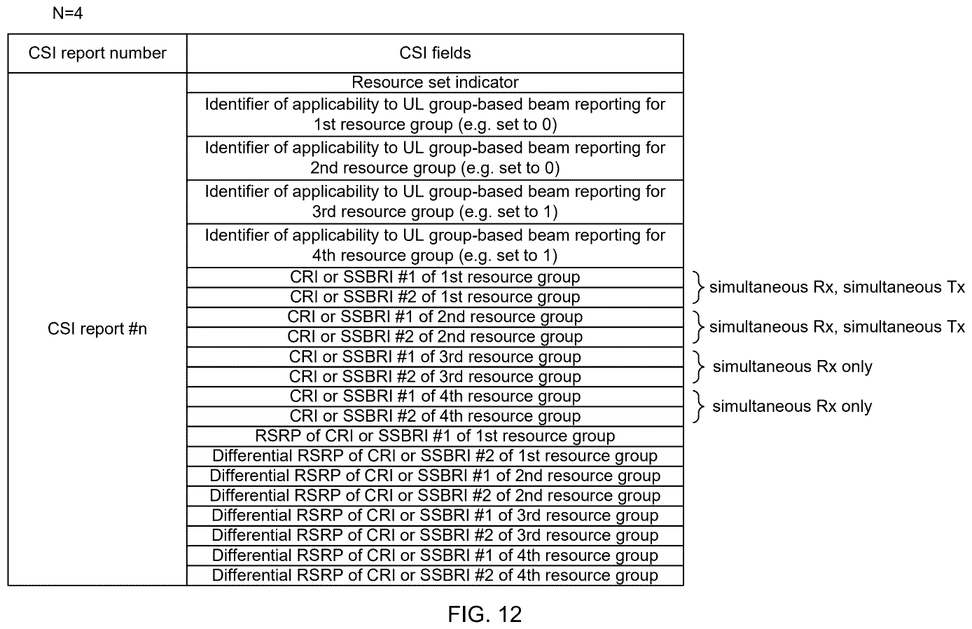

For each group, beam reporting may indicate (e.g., via one bit for each group) whether the UE can transmit two CSI-RS/SSB resources of the group simultaneously (see FIG. 12).

FIG. 12 shows a case of providing a field indicating, among four groups, a group in which UL group-based beam reporting and DL group-based beam reporting are performed in common or a group in which the UE can simultaneously transmit two CSI-RS/SSB resources. Here, a case is shown where an indicator (here, 1 bit) indicating application of the UL group-based beam reporting to each group (here, 1 to 4) is provided. Note that a case is shown where the DL group-based beam reporting is performed for each group.

When an identifier of applicability of UL group-based beam reporting for a resource group (e.g., Identifier of applicability to UL group-based beam reporting for resource group) is configured to 0, a case may be shown where two CSI-RS/SSB resources in the resource group are simultaneously received and further simultaneously transmitted by the UE. Otherwise (e.g., when the identifier is configured to 1), only a case may be shown where the UE receives two CSI-RS/SSB resources in the resource group simultaneously.

FIG. 12 shows a case where identifiers of the first resource group and the second resource group are configured to 0, and identifiers of the third resource group and the fourth resource group are configured to 1. Accordingly, it is possible to flexibly configure whether or not the UL group-based beam reporting and the DL group-based beam reporting are performed in common for each resource group. Note that the contents indicated by the identifiers 0 and 1 may be interchanged.

### Option 1-4

The UE may report a plurality of (e.g., two) CRIS/SSBRIS of N groups in one reporting instance (e.g., a single reporting instance). In this case, the UE may be able to simultaneously transmit two CSI-RS/SSB resources of each group (e.g., every N groups) and may be able to simultaneously receive two CSI-RS/SSB resources of each group for M out of N groups (N≥M or N>M.

The number of groups (for example, at least one of N and M) may be defined in advance in specifications, or may be configured by a higher layer parameter (for example, nrofReportedRSgroup) related to the number of groups.

### Option 1-4-1

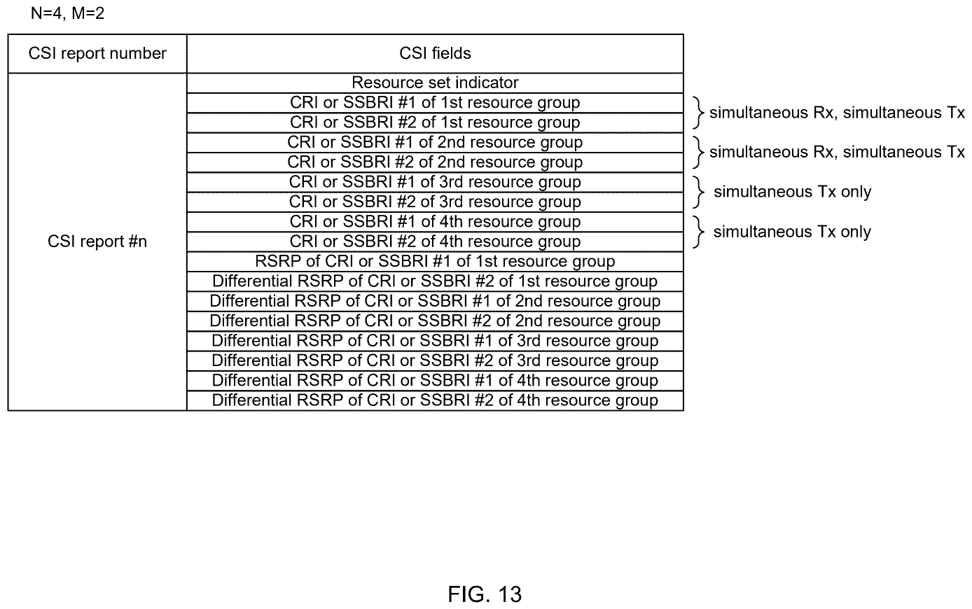

For the first/last M groups of the N groups, the UE may be allowed to receive the CSI-RS/SSB resources of each group simultaneously (see FIG. 13).

FIG. 13 shows a case of providing a field indicating, among four groups, a group in which UL group-based beam reporting and DL group-based beam reporting are performed in common or a group in which the UE can simultaneously receive two CSI-RS/SSB resources. Here, a case is shown where an indicator (here, 1 bit) indicating application of the DL group-based beam reporting to each group (here, 1 to 4) is provided. Note that a case is shown where the UL group-based beam reporting is performed for each group.

Option 1-4-1 may be a default action/default configuration.

### Option 1-4-2

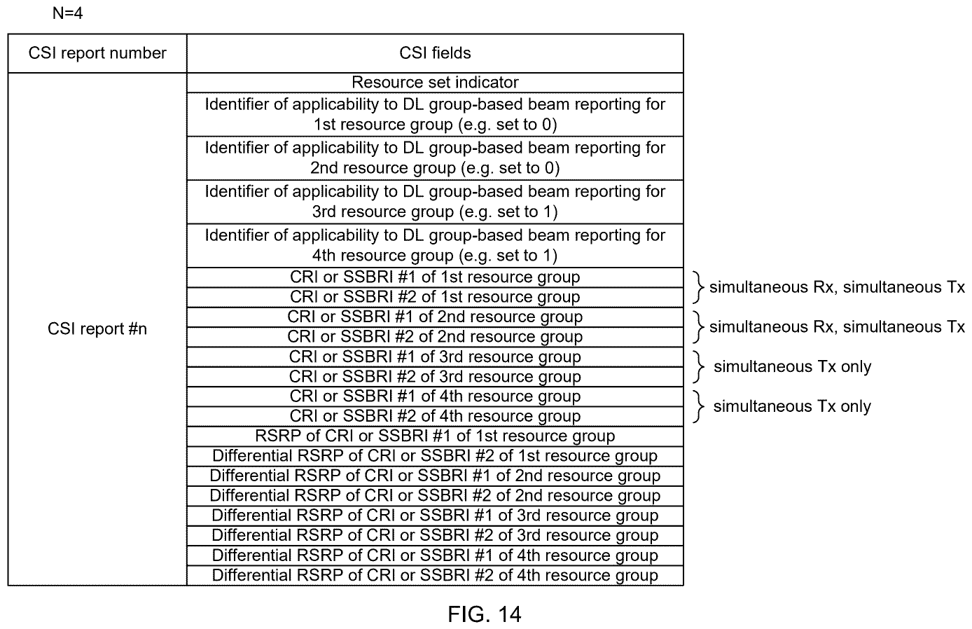

For each group, beam reporting may indicate (e.g., via one bit for each group) whether the UE can transmit two CSI-RS/SSB resources of the group simultaneously (see FIG. 14).

FIG. 14 shows a case of providing a field indicating, among four groups, a group in which UL group-based beam reporting and DL group-based beam reporting are performed in common or a group in which the UE can simultaneously receive two CSI-RS/SSB resources. Here, a case is shown where an indicator (here, 1 bit) indicating application of the DL group-based beam reporting to each group (here, 1 to 4) is provided. Note that a case is shown where the UL group-based beam reporting is performed for each group.

When an identifier of applicability of DL group-based beam reporting for a resource group (e.g., Identifier of applicability to DL group-based beam reporting for resource group) is configured to 0, a case may be shown where two CSI-RS/SSB resources in the resource group are simultaneously received and further simultaneously transmitted by the UE. Otherwise (e.g., when the identifier is configured to 1), only a case may be shown where the UE transmits two CSI-RS/SSB resources in the resource group simultaneously.

FIG. 14 shows a case where identifiers of the first resource group and the second resource group are configured to 0, and identifiers of the third resource group and the fourth resource group are configured to 1. Accordingly, it is possible to flexibly configure whether or not the UL group-based beam reporting and the DL group-based beam reporting are performed in common for each resource group. Note that the contents indicated by the identifiers 0 and 1 may be interchanged.

At least one of Alt. 1-1 to Alt. 1-2 below may be applied to above-described Option 1-1 to Option 1-4.

### Alt. 1-1

When one CSI resource set is configured, two CSI-RS/SSB resources of each group may be selected from the one CSI resource set.

### Alt. 1-2

When two CSI resource sets are configured, two CSI-RS/SSB resources of each group may be selected from the CSI resource set.

In this case, a resource set indicator field may be included in the CSI report, and the resource set indicator may indicate the same meaning as the Rel-17 group-based beam reporting. For example, a channel measurement resource set in which a CRI or SSBRI #1 of a first resource group is reported may be indicated by a value of the resource set indicator. For example, a 1-bit resource set indicator having a value of 0 or 1 may indicate the first or second channel measurement resource set, respectively, and the CRI or SSBRI #1 of the first resource group may be reported therefrom. All remaining resource groups (e.g., when there are other resource groups to be reported) follow the same mapping order as the first resource group. For example, the CRI or SSBRI #1 of all the remaining resource groups may be reported (or selected) from the channel measurement resource set indicated by the resource set indicator.

### Variations

The CSI-RS/SSB resource for the UL group-based beam reporting may be different from the CSI-RS/SSB resource for the DL group-based beam reporting. For example, the UL resources may be a subset of the DL resources.

For example, when X CSI-RS/SSB resources are configured in the CSI resource set, all the resources may be used for the DL group-based beam reporting and some resources may be used for the UL group-based beam reporting. The some resources may be the first/last Y resources. Y may be defined in specifications or may be configured for the UE by a higher layer parameter or the like.

Alternatively, for each CSI-RS/SSB resource, whether the CSI-RS/SSB resource is used for both the DL group-based beam reporting and the UL group-based beam reporting, or the CSI-RS/SSB resource is used only for the DL group-based beam reporting, or the CSI-RS/SSB resource is used only for the UL group-based beam reporting may be explicitly configured/indicated. Note that two configurations/indications of “use for both DL and UL group-based beam reporting”, “use for only DL group-based beam reporting”, and “use for only UL group-based beam reporting” may be supported.

For DL group-based beam reporting, the maximum number of CSI-RS/SSB resources in the CSI resource set may be defined, or may be configured by a higher layer parameter, or the like. For example, the maximum number may be the same as or greater than that in Rel. 17. For example, the maximum number may be 64 or 128. The maximum number may be determined in consideration of the UE Capability.

For UL group-based beam reporting, the maximum number of CSI-RS/SSB resources in the CSI resource set may be defined, or may be configured by a higher layer parameter, or the like. For example, the maximum number may be equal to or less than the maximum number of DL group-based beam reporting. For example, the maximum number may be 32 or 64. The maximum number may be determined in consideration of the UE capability.

For both the DL group-based beam reporting and the UL group-based beam reporting, the maximum number of CSI-RS/SSB resources in the CSI resource set may be defined, or may be configured by a higher layer parameter, or the like.

### Second Embodiment

In a second embodiment, another example of the group-based beam reporting related to UL transmission is described.

In a single reporting instance, the UE may report different beam groups for DL group-based beam reporting and UL group-based beam reporting.

The UE can simultaneously receive (or supports simultaneous reception of) a beam group (a plurality of beam indices included in the same group) for a group corresponding to DL, and can simultaneously transmit (or supports simultaneous transmission of) a beam group (a plurality of beam indices included in the same group) for a group corresponding to UL.

The UE may perform the UL group-based beam reporting by using at least one of the following option 2-1 to option 2-2.

### Option 2-1

The UE may report a plurality of (e.g., two) CRIS/SSBRIs (one group or more) in one reporting instance (e.g., a single reporting instance). This case may mean that the UE can simultaneously receive (or supports reception of) two CRI-RS/SSB resources.

The UE may perform the UL group-based beam reporting by using a CRI/SSBRI or a resource group different from at least one of the CRI/SSBRI and the resource group for the DL group-based beam reporting. For example, the UE may use at least one of the following option 2-1-1 to option 2-1-2.

### Option 2-1-1

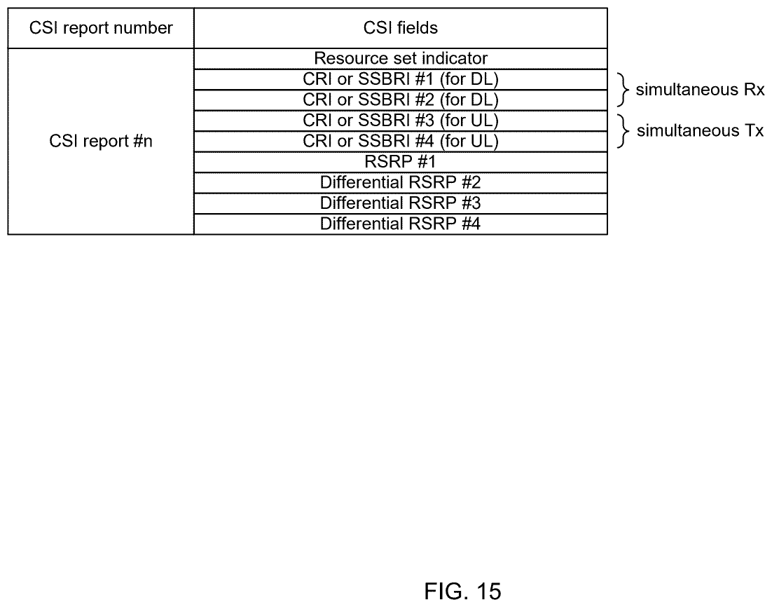

The UE may report one or more (e.g., two) other CRIS/SSBRIS different from the CRI/SSBRI for the DL group base. This case may mean that such other two CSI-RS/SSB resources can be transmitted simultaneously (or supported to transmit) (see FIG. 15).

FIG. 15 is a diagram to show an example of a CSI report when a DL group-based beam reporting and a UL group-based beam reporting are performed separately (or by using different CRIS/SSBRIS). FIG. 15 shows a mapping order of CSI fields included in one report (e.g., n-th CSI report #n) for group-based CSI/RSRP or SSBRI/RSRP reporting.

Here, a case is shown where CRI/SSBRI #1 and CRI/SSBRI #2 are reported for the DL group-based beam reporting, and CRI/SSBRI #3 and CRI/SSBRI #4 are reported for the UL group-based beam reporting. Note that CRI/SSBRI #1 to #4 may correspond to the same resource group (one group).

### Option 2-1-2

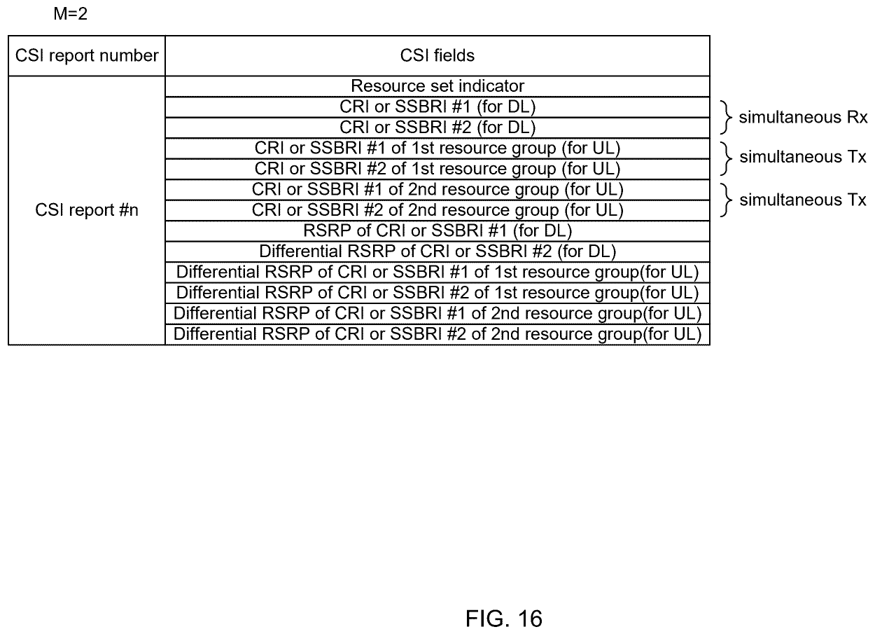

The UE may report other M resource groups different from the resource groups for the DL group base. This case may mean that two CSI-RS/SSB resources of each of such other M resource groups can be simultaneously transmitted (or supported to transmit) (see FIG. 16).

FIG. 16 is a diagram to show an example of a CSI report when the DL group-based beam reporting and the UL group-based beam reporting are performed separately (or by using different resource groups). FIG. 16 illustrates a case where CRI/SSBRI #1 and CRI/SSBRI #2 of one resource group are reported for DL group-based beam reporting, and CRI/SSBRI #1 and CRI/SSBRI #2 of a first resource group and CRI/SSBRI #1 and CRI/SSBRI #2 of a second resource group are reported for UL group-based beam reporting.

The number of resource groups for UL group base (for example, M) may be defined in advance in specifications, or may be configured by a higher layer parameter (for example, nrofReportedRSgroup) related to the number of groups.

### Option 2-2

The UE may report a plurality of (e.g., two) CRIS/SSBRIs for N groups in one reporting instance (e.g., a single reporting instance). This case may mean that the UE can simultaneously receive (or is supported to receive) two CRI-RS/SSB resources of each group.

The number of groups (for example, N) may be defined in advance in specifications, or may be configured by a higher layer parameter (for example, nrofReportedRSgroup) related to the number of groups. Note that, in a case of N=1, option 2-1 may be applied.

The UE may perform the UL group-based beam reporting by using a CRI/SSBRI or a resource group different from at least one of the CRI/SSBRI and the resource group for the DL group-based beam reporting. For example, the UE may use at least one of the following option 2-2-1 to option 2-2-2.

### Option 2-2-1

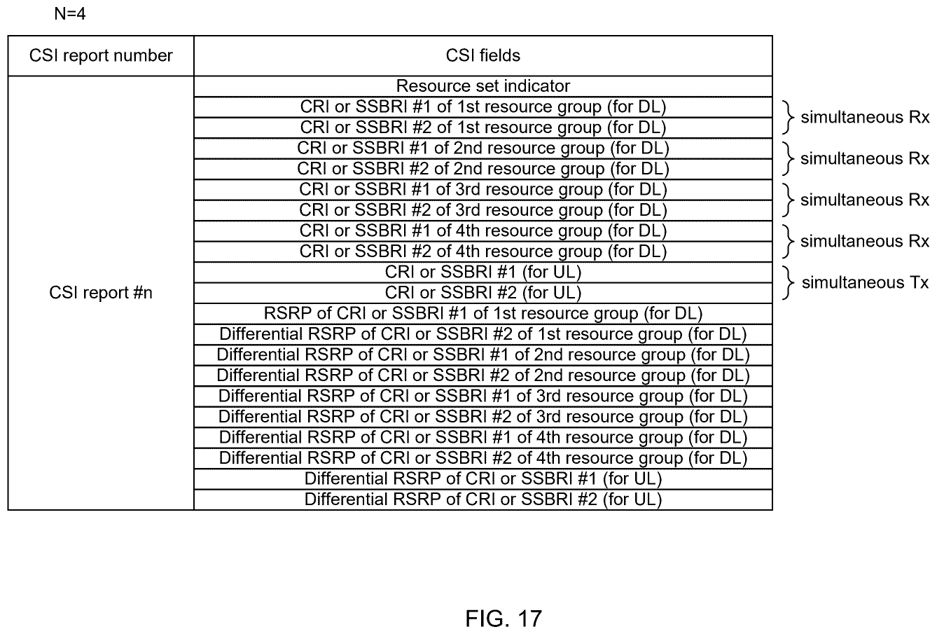

The UE may report one or more (e.g., two) other CRIS/SSBRIS different from the CRI/SSBRI for the DL group base. This case mean that such other two CSI-RS/SSB resources can be simultaneously transmitted (or are supported to transmit) (see FIG. 17).

### Option 2-2-2

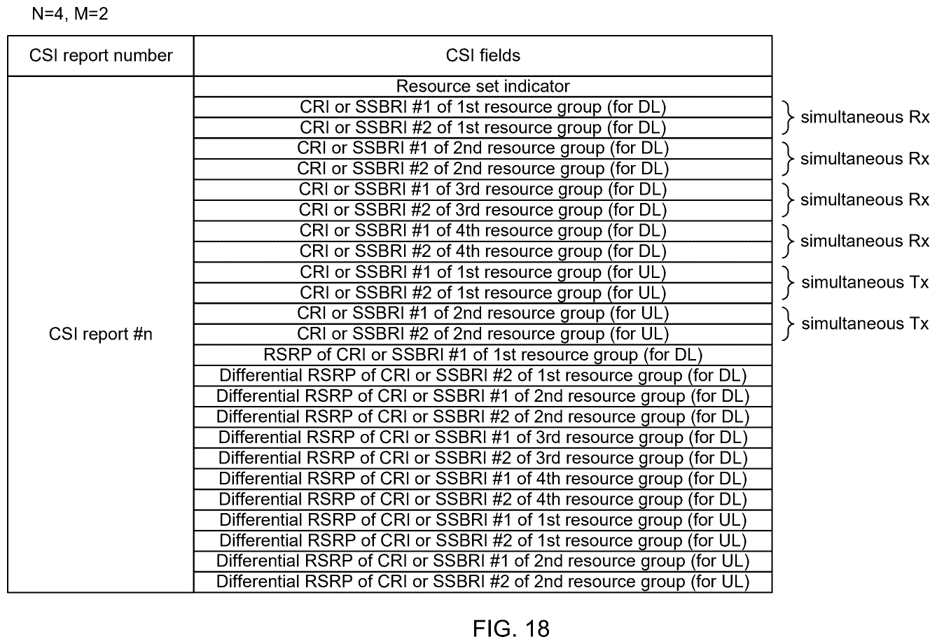

The UE may report other M resource groups different from the resource groups for the DL group base. This case may mean that two CSI-RS/SSB resources of each of such other M resource groups can be simultaneously transmitted (or are supported to transmit) (see FIG. 18).

The numbers of groups (for example, N and M) may be defined in advance in specifications, or may be configured by a higher layer parameter (for example, nrofReportedRSgroup) related to the number of groups. Note that, in a case of M=1, option 2-2-1 may be applied. The number N of resource groups for the DL group base and the number M of resource groups for the UL group base may be configured separately. Alternatively, N=M may be satisfied.

FIG. 18 is a diagram to show an example of a CSI report when the DL group-based beam reporting and the UL group-based beam reporting are performed separately (or by using different resource groups). FIG. 18 illustrates a case where CRI/SSBRI #1 and CRI/SSBRI #2 of the first to fourth resource groups are reported for DL group-based beam reporting, and CRI/SSBRI #1 and CRI/SSBRI #2 of a first resource group and CRI/SSBRI #1 and CRI/SSBRI #2 of a second resource group are reported for UL group-based beam reporting.

At least one of Alt. 2-1 to Alt. 2-2 below may be applied to above-described Option 2-1 to Option 2-2.

### Alt. 2-1

When one CSI resource set is configured, two CSI-RS/SSB resources of each group may be selected from the one CSI resource set.

### Alt. 2-2

When two CSI resource sets are configured, two CSI-RS/SSB resources of each group may be selected from the CSI resource set.

In this case, the two CSI resource sets may be configured in common for the DL beam reporting and the UL beam reporting.

Alternatively, the two CSI resource sets may be separately configured for the DL beam reporting and the UL beam reporting. For example, the two CSI resource sets may be configured for DL beam reporting, and other two CSI resource sets may be configured for the UL beam reporting.

In this case, a resource set indicator field may be included in the CSI report, and the resource set indicator may indicate the same meaning as the Rel-17 group-based beam reporting. For example, a channel measurement resource set in which a CRI or SSBRI #1 of a first resource group is reported may be indicated by a value of the resource set indicator. For example, a 1-bit resource set indicator having a value of 0 or 1 may indicate the first or second channel measurement resource set, respectively, and the CRI or SSBRI #1 of the first resource group may be reported therefrom. All remaining resource groups (e.g., when there are other resource groups to be reported) follow the same mapping order as the first resource group. For example, the CRI or SSBRI #1 of all the remaining resource groups may be reported (or selected) from the channel measurement resource set indicated by the resource set indicator.

Alternatively, two respective resource set indicator fields corresponding to the DL beam reporting and the UL beam reporting may be included in the CSI report.

### Variations

The CSI-RS/SSB resource for the UL group-based beam reporting may be different from the CSI-RS/SSB resource for the DL group-based beam reporting. For example, the UL resources may be a subset of the DL resources.

For example, when X CSI-RS/SSB resources are configured in the CSI resource set, all the resources may be used for the DL group-based beam reporting and some resources may be used for the UL group-based beam reporting. The some resources may be the first/last Y resources. Y may be defined in specifications or may be configured for the UE by a higher layer parameter or the like.

Alternatively, for each CSI-RS/SSB resource, whether the CSI-RS/SSB resource is used for both the DL group-based beam reporting and the UL group-based beam reporting, or the CSI-RS/SSB resource is used only for the DL group-based beam reporting, or the CSI-RS/SSB resource is used only for the UL group-based beam reporting may be explicitly configured/indicated. Note that two configurations/indications of “use for both DL and UL group-based beam reporting”, “use for only DL group-based beam reporting”, and “use for only UL group-based beam reporting” may be supported.

For DL group-based beam reporting, the maximum number of CSI-RS/SSB resources in the CSI resource set may be defined, or may be configured by a higher layer parameter, or the like. For example, the maximum number may be the same as or greater than that in Rel. 17. For example, the maximum number may be 64 or 128. The maximum number may be determined in consideration of the UE capability.

For UL group-based beam reporting, the maximum number of CSI-RS/SSB resources in the CSI resource set may be defined, or may be configured by a higher layer parameter, or the like. For example, the maximum number may be equal to or less than the maximum number of DL group-based beam reporting. For example, the maximum number may be 32 or 64. The maximum number may be determined in consideration of the UE capability.

For both the DL group-based beam reporting and the UL group-based beam reporting, the maximum number of CSI-RS/SSB resources in the CSI resource set may be defined, or may be configured by a higher layer parameter, or the like. The maximum number may be determined in consideration of the UE capability.

### Third Embodiment

In a third embodiment, another example of the group-based beam reporting related to UL transmission is described.

The DL group-based beam report and the UL group-based beam report may be reported in different reporting instances. In a single reporting instance, the UE may perform control to perform only DL group-based beam reporting or only UL group-based beam reporting.

The UE may perform DL group-based beam reporting by using a method of an existing system (for example, in Rel. 15/16/17).

The UE may perform the DL group-based beam reporting by using at least one of the following option 3-1 to option 3-2.

### Option 3-1

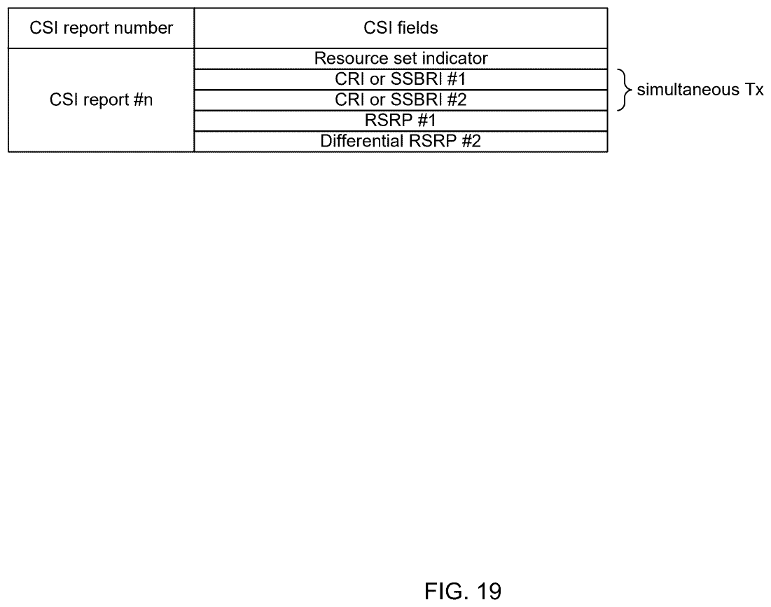

The UE may report two CRIS/SSBRIs as the UL group-based beam reporting. This case mean that the UE can transmit two CRI-RS/SSB resources simultaneously (or support such transmission) (see FIG. 19).

FIG. 19 is a diagram to show an example of a CSI report when the UL group-based beam reporting is performed. FIG. 19 shows a mapping order of CSI fields included in one report (e.g., n-th CSI report #n) for group-based CSI/RSRP SSBRI/RSRP reporting.

Here, a case is illustrated where CRI/SSBRI #1 and CRI/SSBRI #2 are reported as the group-based beam reporting. Note that CRI/SSBRI #1 to #2 may correspond to the same resource group (one group).

### Option 3-2

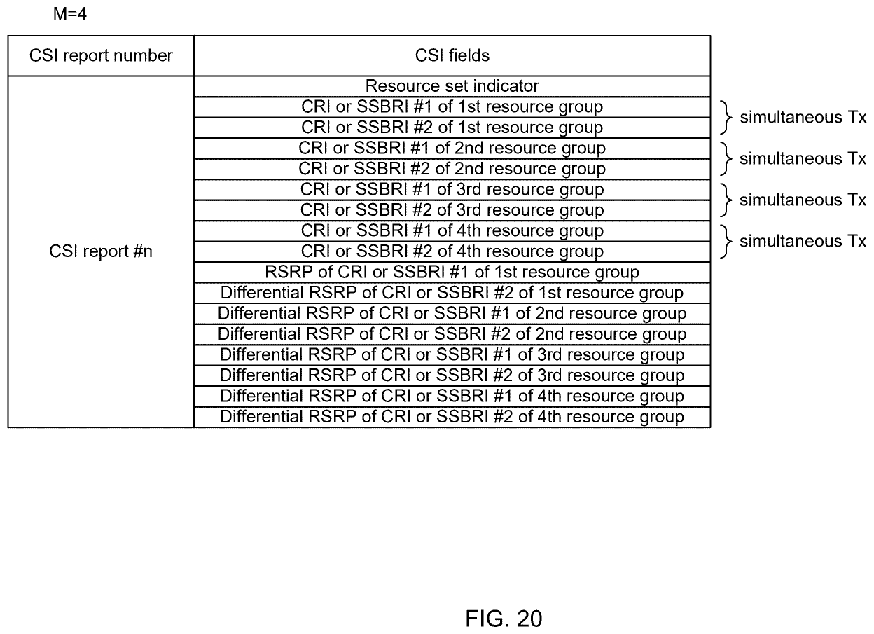

The UE may report two CRI/SSBRI for each of M groups. This Case mean that the UE can transmit two CRI-RS/SSB resources simultaneously (or support such transmission) in each group (see FIG. 20).

FIG. 20 shows a case where CRI/SSBRI #1 and CRI/SSBRI #2 are reported for the first resource group to the fourth resource group (here, M=4) for the UL group-based beam reporting.

The number of groups (for example, M) may be defined in advance in specifications, or may be configured by a higher layer parameter (for example, nrofReportedRSgroup) related to the number of groups. Note that, in a case of M=1, option 3-1 may be applied. The number N of resource groups for the DL group base and the number M of resource groups for the UL group base may be configured separately. Alternatively, N=M may be satisfied.

At least one of Alt. 3-1 to Alt. 3-2 below may be applied to above-described Option 3-1 to Option 3-2.

### Alt. 3-1

When one CSI resource set is configured, two CSI-RS/SSB resources of each group may be selected from the one CSI resource set.

### Alt. 3-2

When two CSI resource sets are configured, two CSI-RS/SSB resources of each group may be selected from the CSI resource set.

In this case, the two CSI resource sets may be configured in common for the DL beam reporting and the UL beam reporting.

Alternatively, the two CSI resource sets may be separately configured for the DL beam reporting and the UL beam reporting. For example, the two CSI resource sets may be configured for DL beam reporting, and other two CSI resource sets may be configured for the UL beam reporting.

In this case, a resource set indicator field may be included in the CSI report, and the resource set indicator may indicate the same meaning as the Rel-17 group-based beam reporting. For example, a channel measurement resource set in which a CRI or SSBRI #1 of a first resource group is reported may be indicated by a value of the resource set indicator. For example, a 1-bit resource set indicator having a value of 0 or 1 may indicate the first or second channel measurement resource set, respectively, and the CRI or SSBRI #1 of the first resource group may be reported therefrom. All remaining resource groups (e.g., when there are other resource groups to be reported) follow the same mapping order as the first resource group. For example, the CRI or SSBRI #1 of all the remaining resource groups may be reported (or selected) from the channel measurement resource set indicated by the resource set indicator.

### Variations

For UL group-based beam reporting, the maximum number of CSI-RS/SSB resources in the CSI resource set may be defined, or may be configured by a higher layer parameter, or the like. For example, the maximum number may be equal to or less than the maximum number of DL group-based beam reporting. For example, the maximum number may be 32 or 64. The maximum number may be determined in consideration of the UE capability.

A plurality of configurations of the first embodiment (at least one of Option 1-1 to Option 1-4), the second embodiment (at least one of Option 2-1 to Option 2-2), and the third embodiment (at least one of Option 3-1 to Option 3-2) may be supported. In this case, which option is applied may be determined based on at least one of a higher layer parameter configured for the UE by the base station and the UE capability.

The first to third embodiments may be applied to a case where joint DL/UL TCI (or unified TCI) in which a common TCI state is applied to a DL channel/signal and a UL channel/signal is supported. In this case, when the common/same CSI resource set and the common/same beam reported for DL/UL are appropriate, the base station can appropriately use the joint DL/UL TCI. For separate DL/UL TCIs or separate panels for DL/UL, separate/different CSI resource sets for DL and UL and separate/different beam reporting are appropriate.

### Fourth Embodiment

In a fourth embodiment, a configuration (or

enabling/disabling) of UL group-based beam reporting /L group-based beam reporting is described.

The UE may judge the configuration (or enabling/disabling) of the UL group-based beam reporting/DL group-based beam reporting, based on a given condition/higher layer parameter.

For example, when the third embodiment is supported (for example, when the DL group-based beam reporting and the UL group-based beam reporting are performed in different CSI report instances), the configuration (or enabling/disabling) of the UL group-based beam reporting/the DL group-based beam reporting may be separately performed.

For example, the DL group-based beam reporting may be enabled by a higher layer parameter (e.g., groupBasedBeamReporting or groupBasedBeamReporting-r17) of an existing system. On the other hand, the UL group-based beam reporting may be enabled by a new higher layer parameter (e.g., ULgroupBasedBeamReporting).

For the CSI report configuration (for example, CSI-report config), when the new higher layer parameter is enabled, the third embodiment may be applied to the UL group-based beam reporting.

When the first embodiment (at least one of Option 1-1 to Option 1-4)/the second embodiment (at least one of Option 2-1 to Option 2-2) is supported (for example, when the DL group-based beam reporting and the UL group-based beam reporting are performed in one CSI report instance), at least one of Alt. 4-1 to Alt. 4-2 below may be applied.

### Alt. 4-1

The configuration (or enabling/disabling) of the UL group-based beam reporting/DL group-based beam reporting may be separately performed. For example, the DL group-based beam reporting may be enabled by a higher layer parameter (e.g., groupBasedBeamReporting or groupBasedBeamReporting-r17) of an existing system. On the other hand, the UL group-based beam reporting may be enabled by a new higher layer parameter (e. g., ULgroupBasedBeamReporting).

### Case 4-1

For the CSI report configuration (for example, CSI-report config), when a higher layer parameter for the DL group-based beam reporting is enabled and a higher layer parameter for the UL group-based beam reporting is not enabled, the DL group-based beam reporting of an existing system may be applied.

### Case 4-2

For the CSI report configuration (for example, CSI-report config), when the higher layer parameter for the DL group-based beam reporting is enabled and the higher layer parameter for the UL group-based beam reporting is also enabled, the first embodiment/second embodiment may be applied.

### Case 4-3

For the CSI report configuration (for example, CSI-report config), when the higher layer parameter for the DL group-based beam reporting is not enabled and the higher layer parameter for the UL group-based beam reporting is enabled, the following Alt. 4-1-a/Alt. 4-1-b may be applied.

### Alt. 4-1-a

The third embodiment may be applied and the UL group-based beam reporting may be performed. This case may mean that the third embodiment is supported in addition to the first embodiment/second embodiment.

### Alt. 4-1-b

The UE may not assume case 4-3 (e.g., only higher layer parameters for UL group-based beam reporting are enabled). In other words, a configuration in which only the UL group-based beam reporting is performed may not be supported.

### Alt. 4-2

The first embodiment (at least one of Option 1-1 to Option 1-4)/the second embodiment (at least one of Option 2-1 to Option 2-2) may be configured (for example, enabled) by a new higher layer parameter. When the UE is enabled by the new higher layer parameter, the UE may be applied with the first embodiment (at least one of Option 1-1 to Option 1-4)/the second embodiment (at least one of Option 2-1 to Option 2-2).

### Variations

The CSI report of the first embodiment to the fourth embodiment may include panel information. For example, the UE may include information related to a panel index in a CSI report in the DL group-based beam reporting/UL group-based beam reporting. The UE may report one panel index information per CRI/SSBRI for reporting. Alternatively, the UE may report one piece of panel index information for each resource group for which reporting is performed.

### UE Capability Information

In the first to fourth embodiments, the following UE capability may be configured. Note that the following UE capabilities may each be interpreted as a parameter (for example, a higher layer parameter) configured for the UE by a network (for example, the base station).

The UE capability information related to whether or not to support the UL group-based beam reporting may be defined.

The UE capability information related to whether or not to support the UL group-based beam reporting in the first embodiment (at least one of Option 1-1 to Option 1-4), the second embodiment (at least one of Option 2-1 to Option 2-2), and the third embodiment (at least one of Option 3-1 to Option 3-2) may be defined.

The first embodiment to the fourth embodiment may be configured to be applied to the UE that supports/reports at least one of the above-described UE capabilities. Alternatively, the first to fourth embodiments may be applied to the UE configured by the network.

### Supplementary Note

With respect to one embodiment of the present disclosure, supplementary notes of the following inventions are added.

### Supplementary Note 1

A terminal including:
a receiving section that receives resource information related to a channel state information resource available for UL group-based beam reporting; and
a control section that performs channel state information reporting including at least one of UL group-based beam reporting and DL group-based beam reporting, based on the resource information.

### Supplementary Note 2

The terminal according to supplementary note 1, wherein the control section performs the UL group-based beam reporting and the DL group-based beam reporting by using a same resource index of a same group included in one channel state information report.

### Supplementary Note 3

The terminal according to supplementary note 1 or 2, wherein the control section performs the UL group-based beam reporting and the DL group-based beam reporting by using at least one of different groups and different resource indices included in one channel state information report.

### Supplementary Note 4

The terminal according to any one of supplementary notes 1 to 3, wherein the control section performs the UL group-based beam reporting and the DL group-based beam reporting by using different channel state information reports.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

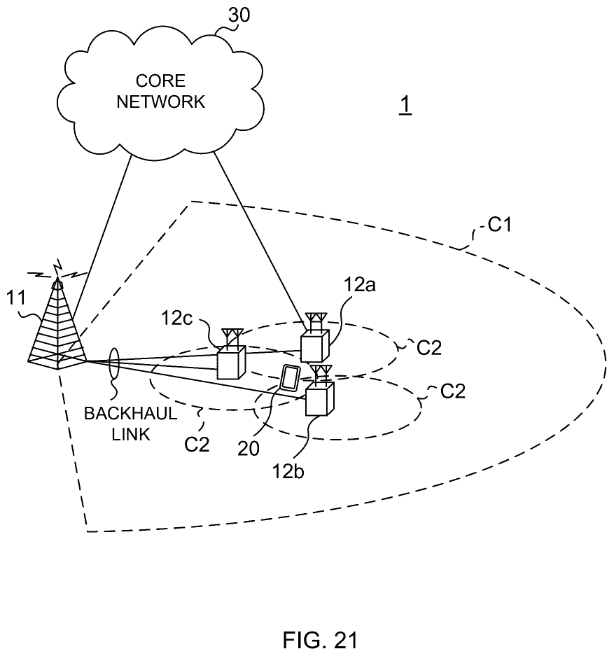

FIG. 21 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR 2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.” The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

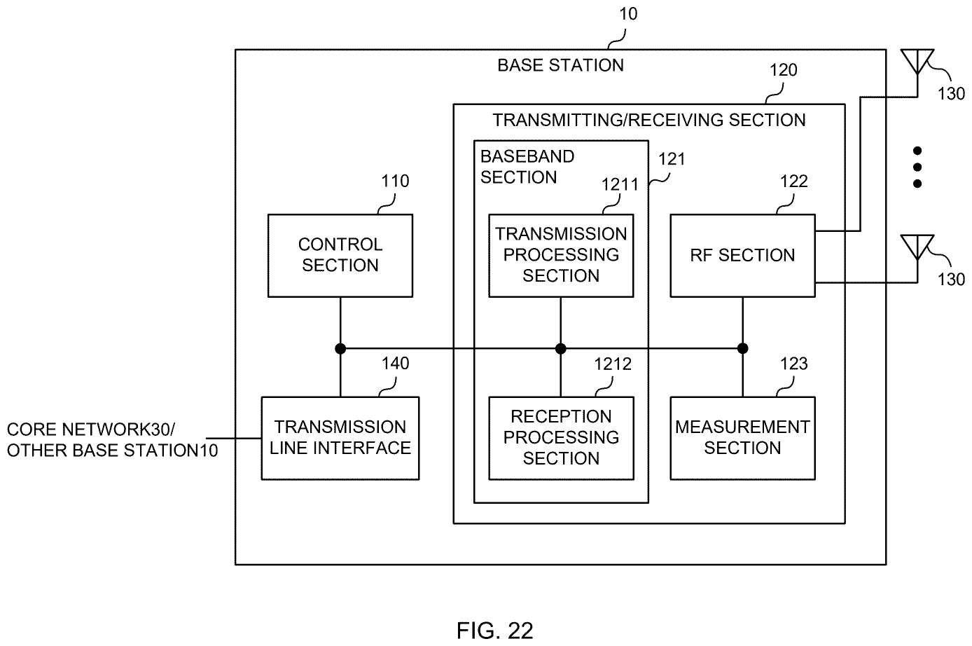

FIG. 22 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal.

For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit resource information related to a channel state information resource available for UL group-based beam reporting. The transmitting/receiving section 120 may receive channel state information report including at least one of UL group-based beam reporting and DL group-based beam reporting, reported from the terminal.

The control section 110 may indicate, to the terminal, resource information related to a channel state information resource available for UL group-based beam reporting.

### User Terminal

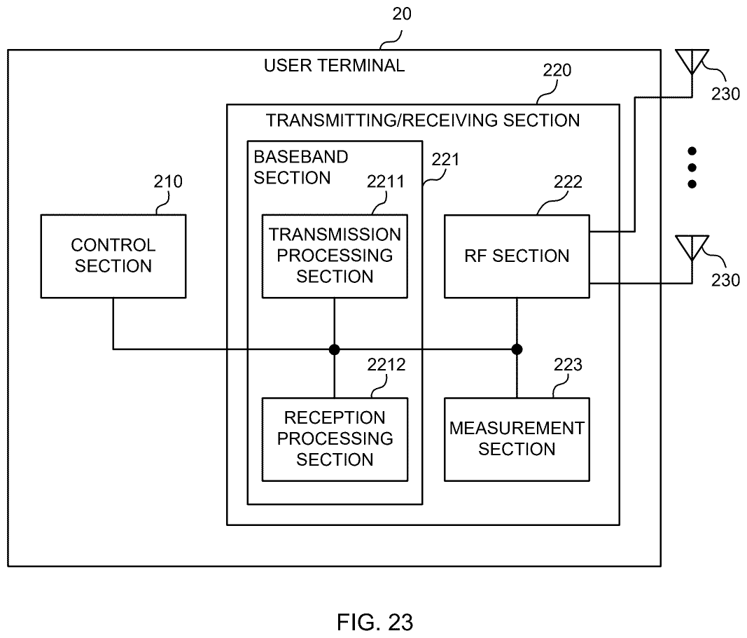

FIG. 23 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section.

The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DET processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal.

For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive resource information related to a channel state information resource available for UL group-based beam reporting.

The control section 210 may control to perform channel state information reporting including at least one of UL group-based beam reporting and DL group-based beam reporting, based on the resource information.

The control section 210 may control to perform the UL group-based beam reporting and the DL group-based beam reporting by using a same resource index of a same group included in one channel state information report.

The control section 210 may control to perform the UL group-based beam reporting and the DL group-based beam reporting by using at least one of different groups and different resource indices included in one channel state information report.

The control section may control to perform the UL group-based beam reporting and the DL group-based beam reporting by using different channel state information reports.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

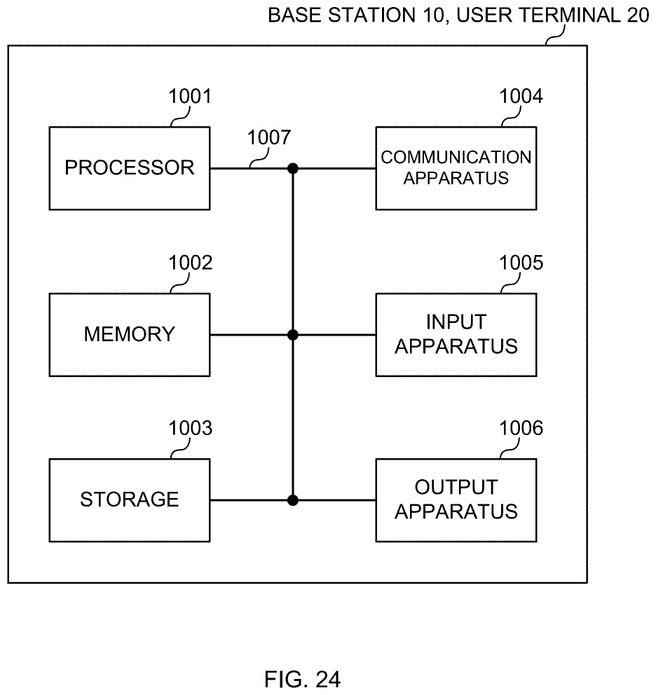

For example, a base station, a user terminal, and so on according to one embodiment of the present disclosure may function as a computer that executes the processes of the radio communication method of the present disclosure. FIG. 24 is a diagram to show an example of a hardware structure of the base station and the user terminal according to one embodiment.

Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used.

For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interpreted as a case that the base station indicates, for the terminal, control/operation based on the information, and vice versa.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IOT) device such as a sensor.

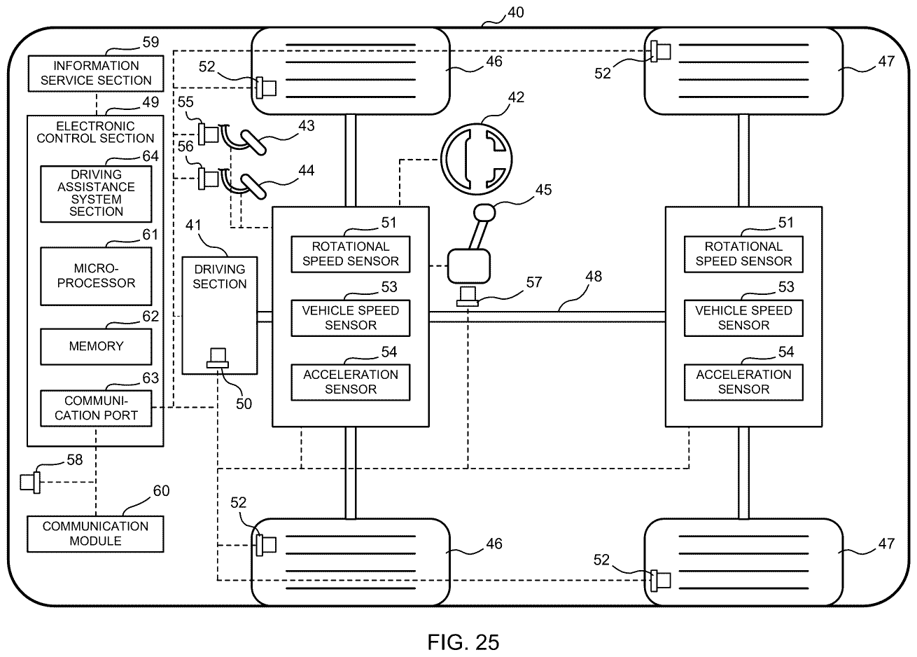

FIG. 25 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle.

The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “less than or equal to,” “less than,” “greater than or equal to,” “more than,” “equal to,” and the like may be interchangeably interpreted. In the present disclosure, the words meaning “good,” “poor”, “large,” “small,” “high,” “low,” “fast,” “slow,” “broad,” “narrow,” and the like may be interchangeably interpreted irrespective of the positive degree, the comparative degree, and the superlative degree. In the present disclosure, the words meaning “good,” “poor,” “large,” “small,” “high,” “low,” “fast,” “slow,” “broad,” “narrow,” and the like may be interpreted as expressions with “i th” (i is any integer), and vice versa, irrespective of the positive degree, the comparative degree, and the superlative degree (for example, “highest” and “i th highest” may be interchangeably interpreted).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

The present application is based on Japanese Patent Application No. 2022-082340 filed on May 19, 2022, the entire contents of which are incorporated herein by reference.

1. A terminal comprising:
a receiving section that receives resource information related to a channel state information resource available for UL group-based beam reporting; and
a control section that performs channel state information reporting including at least one of UL group-based beam reporting and DL group-based beam reporting, based on the resource information.

2. The terminal according to claim 1, wherein
the control section performs the UL group-based beam reporting and the DL group-based beam reporting by using a same resource index of a same group included in one channel state information report.

3. The terminal according to claim 1, wherein
the control section performs the UL group-based beam reporting and the DL group-based beam reporting by using at least one of different groups and different resource indices included in one channel state information report.

4. The terminal according to claim 1, wherein
the control section performs the UL group-based beam reporting and the DL group-based beam reporting by using different channel state information reports.

5. A radio communication method for a terminal, the radio communication method comprising:
receiving resource information related to a channel state information resource available for UL group-based beam reporting; and
performing channel state information reporting including at least one of UL group-based beam reporting and DL group-based beam reporting, based on the resource information.

6. A base station comprising:
a control section that indicates, to a terminal, resource information related to a channel state information resource available for UL group-based beam reporting; and
a receiving section that receives channel state information report including at least one of UL group-based beam reporting and DL group-based beam reporting, based on the resource information.
